(19) United States
(12) Patent Application Publication
(10) Pub. No.: US 2003/0158750 A1
(43) Pub. Date: Aug. 21, 2003

(54) Method and apparatus for electronic processing of claims

(76) Inventors: Sherron A. Banks, Plainsboro, NJ (US); Larry J. Haden, Fairfax Station, VA (US); Melissa L. Metzfield, Ashburn, VA (US); John K. Swayze, Bethesda, MD (US); Michael F. Wingo, Vienna, VA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/213,442

(22) Filed: Aug. 7, 2002

Related U.S. Application Data
(60) Provisional application No. 60/312,787, filed on Aug. 17, 2001.

(51) Int. Cl. G06F 17/60

(52) U.S. Cl. 705/2

(57) ABSTRACT

A computer implemented method for processing a compensation request is disclosed. This method includes receiving the compensation request. The compensation request is processed on a computer using a categorization decision tree to determine the value of the compensation request. An offer to settle the compensation request is transmitted, with the value of the offer based on the result of the compensation request processing using the categorization decision tree.

This application claims the benefit of U.S. provisional patent application No. 60/312,787 filed Aug. 17, 2001, entitled “METHOD AND APPARATUS FOR ELECTRONIC PROCESSING OF CLAIMS.” The content of this provisional patent application is hereby incorporated by reference.

### BACKGROUND OF THE INVENTION

1. Field of the Invention

The present invention relates to computer-implemented claim processing, and more particularly to electronic claim processing utilized to process claims related to toxic torts, asbestos exposure, litigation settlements, Court ordered settlements, and/or other settlements.

2. Description of the Related Art

The typical method of processing claims or compensation requests involves filing either a paper or an electronic claim. Thereafter, the claim and supporting evidence is reviewed by an individual employed by a claim processor, an insurance company, or other entity. After this review, the claim is either allowed, denied, or further information is requested. The claim status may be available electronically.

The process requires a large number of employees to timely process claims. These employees increase the overhead of the claim processor, insurance company, or other entity. The larger overhead typically results in reduced profit margins. Alternatively, if a smaller claim processing staff is employed, the time delay is longer between claim filing and the claimant receiving payment. Longer claim processing times, however, reduce customer satisfaction. In structured settlements for asbestos and other toxic exposures, this delay may result in the claimant not receiving payment for their claim prior to their demise from an injury and/or illness related to their exposure.

Therefore, there is a need for a claim processing system that can reduce the costs associated with claim processing. This need is particularly acute for structured settlements associated with asbestos and/or other toxic exposures, since available assets to pay claims are often limited. A reduction in claim administration costs should result in a greater percentage of the assets paid to claimants. A claim processing system is also needed that enables prompt, consistent, and equitable claim settlement.

### SUMMARY OF THE INVENTION

A computer-implemented method for processing requests for compensation. This method includes receiving a compensation request. The compensation request is processed on a computer using a categorization decision tree to determine the value of the compensation request. An offer to settle the compensation request is transmitted. The value of the offer is based on the result of the compensation request processing using the categorization decision tree.

In an alternative embodiment, the method includes receiving a compensation request. The compensation request is processed on a computer using an expert system to determine the value of the compensation request. An offer to settle the compensation request is then transmitted. The value of the offer is based on the result of the compensation request processing using the expert system.

Also disclosed is a computer device containing a program for processing compensation requests. The device includes a computer readable medium. A data structure for processing the compensation request using a categorization decision tree to determine the value of the compensation request is stored on the medium.

Further disclosed is a computer system for processing compensation requests. The system includes a computer having: a processor; an input device for inputting data into the computer; an output device for outputting data from the computer; and at least one storage medium. A data structure for processing the compensation request, using a categorization decision tree to determine the value of the claim, is stored on the medium.

### BRIEF DESCRIPTION OF THE DRAWINGS

The accompanying drawings incorporated in and forming part of the specification illustrate several aspects of the present invention, and together with the description serve to explain the principles of the invention. In the drawings:

FIG. 1A illustrates a high-level flow chart for the compensation request or claim process of the present invention;

FIG. 1B illustrates an exemplary high-level categorization decision tree used to value asbestos claims against the Manville Trust;

FIG. 1C illustrates an exemplary computer system that could perform the process of FIG. 1A;

FIG. 2 shows additional but optional steps/interactions for an exemplary preferred embodiment;

FIGS. 3-5 illustrate a flow chart for an exemplary preferred embodiment of the process illustrated in FIG. 1A;

FIGS. 6-7 illustrate an exemplary flow chart for the categorization decision tree illustrated in FIG. 1B;

FIGS. 8-11 provide exemplary question blocks for the categorization decision tree illustrated in FIGS. 6-7;

FIGS. 12, 12-1, -2, -3, and -4 illustrate an exemplary web map for the current web based embodiment showing the various interconnections/links between active server pages;

FIGS. 13-20 show an exemplary menu structure employed in the web based embodiment;

FIGS. 21, 21-1, and 21-2 illustrate the element level objects and their associated properties, as utilized in the current preferred embodiment;

FIGS. 22 and 22-1 to 22-6 illustrate the data level objects and their associated properties, as utilized in the current preferred embodiment;

FIGS. 23, 23-1, and 23-2 illustrate the business level objects and their associated properties, as utilized in the current preferred embodiment;

FIGS. 24 and 25 are exemplary use case diagrams.;

FIGS. 26-42 provide detailed functional flow charts for the web based version of the claim process;

FIGS. 43-47 provide detailed functional flow charts for the web based version of the CDT process shown in FIGS. 6 and 7; and

FIGS. 48 and 48-1 to 48-3 provide a flow chart for the batch processing illustrated in FIGS. 3-5.

Reference will now be made in detail to the invention, examples of which are illustrated in the accompanying drawings.

### DETAILED DESCRIPTION OF THE INVENTION

Definitions

Claim—Money demanded in accordance with an insurance policy, legal right, contract, agreement, and/or court order.

Compensation request—a claim.

Overview

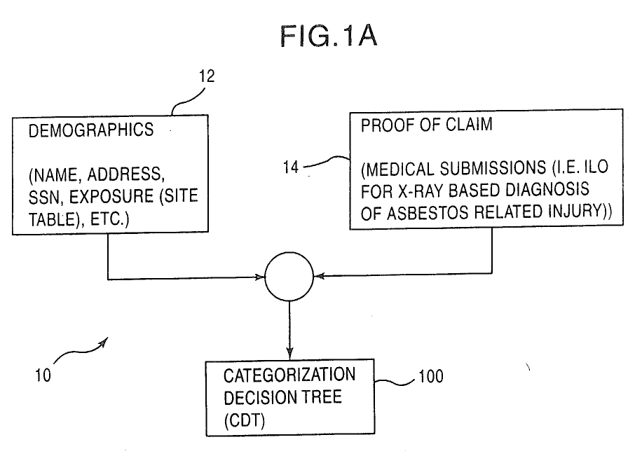

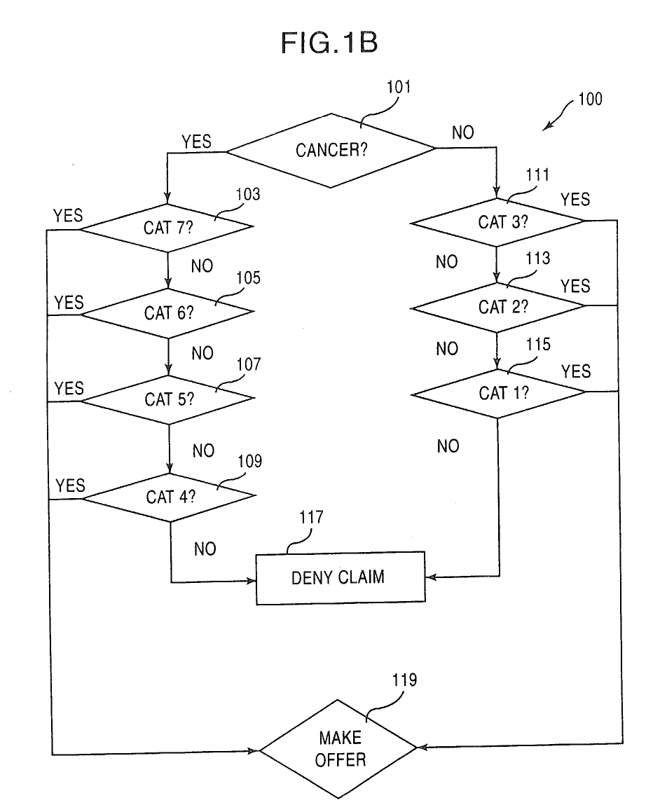

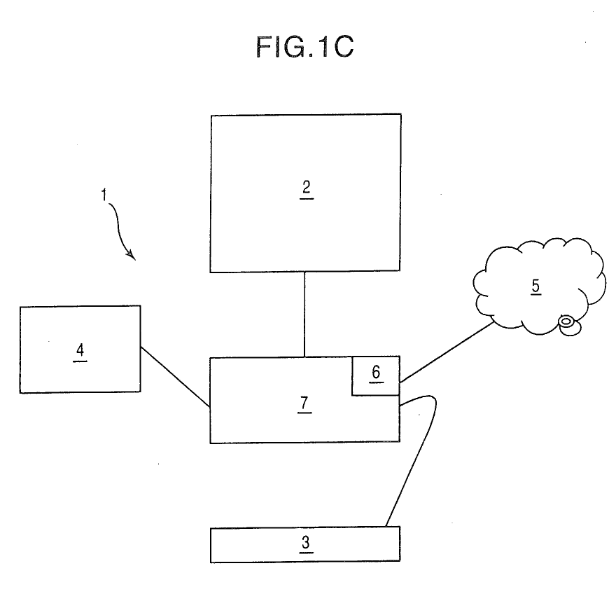

FIG. 1A provides an overview flow diagram that illustrates an exemplary claim process 10. The components of this process include receiving demographic information 12 on the claimant and processing the claim using a categorization decision tree 100.

The demographic information 12 may contain information such as name, social security number, address, and exposure (the exposure information may contain a location or site table and the type of exposure, i.e., radiation, asbestos, or other toxic substance or material). The claim may also require proof of claim information 14. For example, the proof of claim information may include medical submissions. The preferred embodiment has been developed for handling asbestos claims. Consequently, the proof of claim information 14 may include an International Labor Organization classification (ILO) for X-ray based diagnosis. For other claims, the submission of other proof may be required. Some claims may not require proof of claim information 14. In some embodiments, the proof of claim information 14 may be obtained at the same time as the demographic information 12.

The claim is evaluated and valued using a categorization decision tree (CDT) 100. In an interactive embodiment, an individual may provide information, or answer questions that provide information as part of the CDT 100. This information may be proof of claim information 14 or may be a portion of proof of claim information 14. In other embodiments, the CDT 100 may process the previously entered information without the user required to enter additional information. The use of the categorization decision tree 100 may enable faster claim processing, lower overhead, and/or a reduction in paper files.

A reduction in overhead cost may provide higher profit margins for the claim processor. Alternatively, lower overhead may result in lower operating costs, which may result in lower medical premiums (if used by a medical insurer). In the case of an asbestos trust, a larger percentage of trust assets could be distributed to those injured from the asbestos produced by the company, whose assets have been placed in the trust.

In a claim process using a CDT 100 less time may elapse between filing and settlement. This is an advantage to individuals making claims, since they will receive prompt settlement. This is particularly important when the claimant has a short life expectancy or is suffering from an extreme medical condition. This process also provides: control over timing allowing the claimant to resolve litigation and other settlements first; medical updates on a client friendly schedule; and time to locate and obtain client settlement authority.

The claim process 10 may permit status checking at flexible times including outside “normal” working hours. The use of electronic claim filing and processing should generate less paper and fewer file turns. The claim process 10 may also enable attorneys and other organizations filing claims to efficiently handle a higher claim volume (i.e., at a lower cost), and to handle claims against multiple entities with each having different claim criteria.

FIG. 1B illustrates a overview of the CDT 100 for the present preferred embodiment. Since this embodiment relates to asbestos claims against the Manville Trust, the CDT 100 illustrated reflects the requirements of the Trust Distribution Process document approved by the Court. This CDT provides a systematic methodology for valuing a claim at the highest value for which the claimant meets the requirements. Consequently, in block 101 the illustrated CDT 100 determines if the claimant has a diagnosed cancer that is related to the claimant's asbestos exposure.

If the claimant has related cancer, then the CDT 100 determines the type and value of the claim using blocks 103, 105, 107, and 109. Since a cancer classified as a Category 7 (CAT 7) claim has the largest value, the CDT 100 determines if the claimant meets the requirements for this claim category first in block 103. When the claimant does not meet the requirements for a Category 7 cancer claim, the CDT determines if the claimant meets the requirements for a Category 6 (CAT 6) claim in block 105. A similar process is followed for Category 5 (CAT 5) claims in block 107 and Category 4 (CAT 4) claims in block 109. If the claimant fails to meet the requirements for any of the cancer related claim categories the claim may be denied by claim process 10 in block 117. In some embodiments, the CDT 100 may provide the user the option to see if the claimant meets the requirements for one of the non-cancer claim categories.

When the claimant does not have a related cancer in block 101 or in some embodiments fails to meet the requirements for a cancer related claim, the CDT determines if the claimant meets the requirements for a non-cancer asbestos injury claim in blocks 111, 113, and 115. Since a non-cancer injury classified as a Category 3 (CAT 3) claim has the largest value of the non-cancer claims, the CDT 100 determines if the claimant meets the requirements for this claim category in block 111. When the claimant does not meet the requirements for a Category 3 claim, the CDT determines if the claimant meets the requirements for a Category 2 (CAT 2) claim in block 113. A similar process is followed for Category 1 (CAT 1) claims in block 115. If the claimant fails to meet the requirements for any of the non-cancer related claim categories, then the claim is denied by claim process 10 in block 117.

When the claimant meets the requirements for a particular claim category, the CDT 100 returns the value of the claim or the claim category to the claim process 10. An offer is then made to the claimant in block 119.

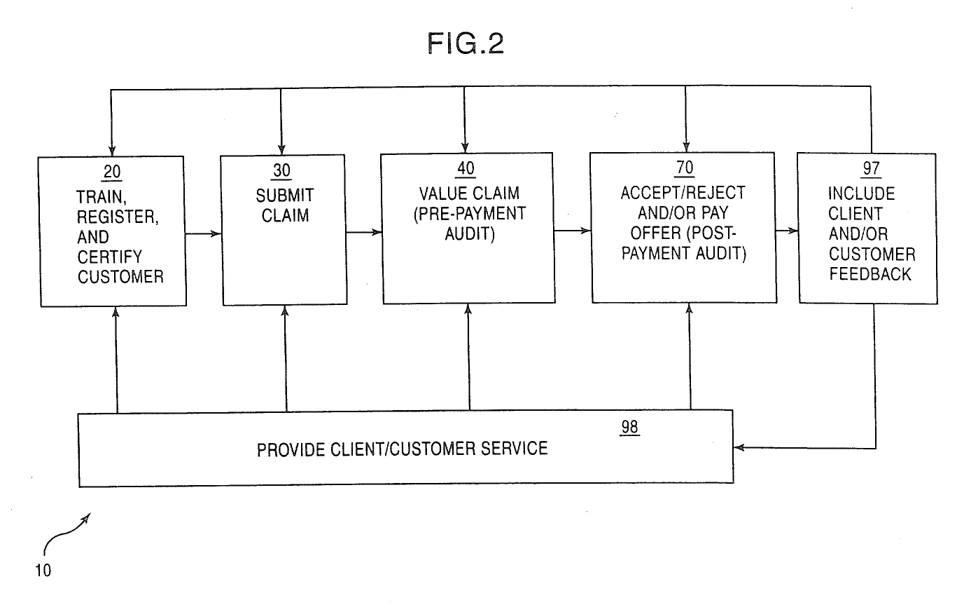

FIG. 2 illustrates additional steps that may be included in the claim process 10. This process may include training, registering, and/or certifying the customer at block 20. Typically, the customer will be the law firm and/or other entity who will file the claim on behalf of their client. The training may include training in the use of the claim processing software and the interpretation of medical documents. The registration may also include execution of an agreement that may identify the users, and the security level and/or access level for each user. The registration and/or agreement may also specify requirements for maintenance of supporting documentation together with the ability of the claim processor to conduct audits on the supporting documentation. This agreement may also include quality control testing procedures, payment requirements and a disclosure of service levels. In an effort to maintain a high level of quality control in the claim processing system, the customer may be certified by passing a certification test. Typically, the certification test will have users submit a set of practice claims to verify their proficiency in using the claim processing system and interpretation of medical documents.

Claim submission 30 may be accomplished in at least three different ways. For example, claims may be submitted using an on-line system; batch file submission; and/or paper claim submission.

The current on-line system is a web-based system accessible from the Internet. In this embodiment, a trained, registered, certified customer submits claims using the Internet. In other embodiments, an untrained individual representing themselves may submit a claim using this method.

When using the on-line system, a customer may submit the claim interactively using a website. At this website, the customer may enter basic claim information, i.e., demographics 12 and/or proof of claim 14 information into an on-line form. The customer may also send the required proof of claim 14 materials (i.e., medical submissions) in any manner supported by the claim processor, or the claim processing system 10 (i.e., by electronic file, or by a tangible document). The customer may then execute the categorization decision tree 100 to analyze and value the claim.

Using batch file submission, a customer would place a group of claims into a file. This file may be transmitted to the claim processor by file download, e-mail attachment, CD-ROM, floppy disk and/or other computer-readable media. With batch file submission, the categorization decision tree 100 may be executed interactively, by dynamic link, or by the user with the results of the categorization decision tree transmitted as part of the file. The proof of claim information 14 may be submitted as an electronic file (either included in the claim file or as a separate file), or as a paper document.

For paper claim submission, the process of submitting a claim may require filling out the appropriate claim form. This process may also require providing the appropriate proof of claim (i.e., in the case of an asbestos injury an ILO may be required). The paper form, when received by the claim processor, may be scanned, or the information from claim otherwise entered into the claim processing system 10.

Preferably, a high level of security is associated with access to the claim processing system. A high level of security, if implemented, will permit a customer to only access the claims filed by that customer. By limiting claim access, the claimant's privacy is protected.

If an untrained individual user is permitted to use the on-line or batch submission methods, a higher level of quality control checking may be desirable. It is also within the expectations of the present invention that a spouse, significant other, and/or friend may submit a claim on behalf of a claimant.

Electronic claim submission and/or processing may enable monitoring and/or quality checks to ensure that quality control requirements are met. For example, quality control checks for a random sample of claims, or for selected targets (i.e., law firm, region or other criteria) could be performed.

In block 40, the claim processor receives the claim and, if necessary, performs and/or processes the claim through the categorization decision tree 100. A settlement offer is also made in block 40. This block may also provide for Pre-offer, pre-payment, and other quality control audits may be conducted on a random sample of claims and/or for selected targets. The selected targets may include specific regions, specific customers, or other criteria determined by the claim processor.

In processing the claim, the categorization decision tree 100 determines if the requirements for a specific settlement value are met, i.e., exposure, latency, product, identification, medical condition, and other requirements for a particular claim value. After valuing the claim, the claim processor and/or claim processing system 10, typically send a settlement offer. In some embodiments (i.e., medical insurance), the claim may be paid after verifying the claim using the categorization decision tree 100.

In block 70, the claimant or the customer on behalf of the claimant accept or reject the offer. Some embodiments permit the customer and/or the claimant to accept or reject the offer using an interactive web site, e-mail, or other electronic communication method. If the offer is accepted, the offer may be paid using electronic funds transfer, and/or a paper check. In some cases, a post payment audit may be conducted to verify that the customer employed proper quality controls.

In the current embodiment, if the customer believes that the claim value was incorrect, they may elect individual examination of the claim, Alternative Dispute Resolution (ADR), or to resubmit the claim.

Some embodiments may include block 97, which enables or provides an opportunity for customer feedback. Optional Block 98 makes provision for providing client/customer service using a help desk or similar telephone or e-mail-based customer service center.

FIG. 1C illustrates an exemplary computer system 1 that could be used to perform claim process 10. This system typically includes a central processor 7. The processor 7 may contain a central processor unit (CPU); volatile and non-volatile memory (for example, RAM and/or ROM); input/output controllers (for example, keyboard, mouse, serial, parallel, SCSI, and/or USB); display controller (for example VGA, SVGA, and/or XGA); network interface (for example, Ethernet); modem (for example, telephone, DSL, and/or cable); and/or disk drive associated controller (for example, floppy disk, hard disk, CDROM, and/or DVD) connected together with a motherboard. In the illustrated system 1, processor 7 is connected to a keyboard 3, printer 4, video monitor 2, and network 5. This network could include an intranet, a local or wide area network, and/or the internet. The processors7 is shown with a disk drive 6. While optional, this drive could be one or more of the following: floppy drive, hard drive, CDROM drive, and/or DVD drive. The entire claim process 10 may reside on a stand-alone computer system 1; may be distributed over a plurality of computers in network 5; and/or may reside on a network server.

Claim Process

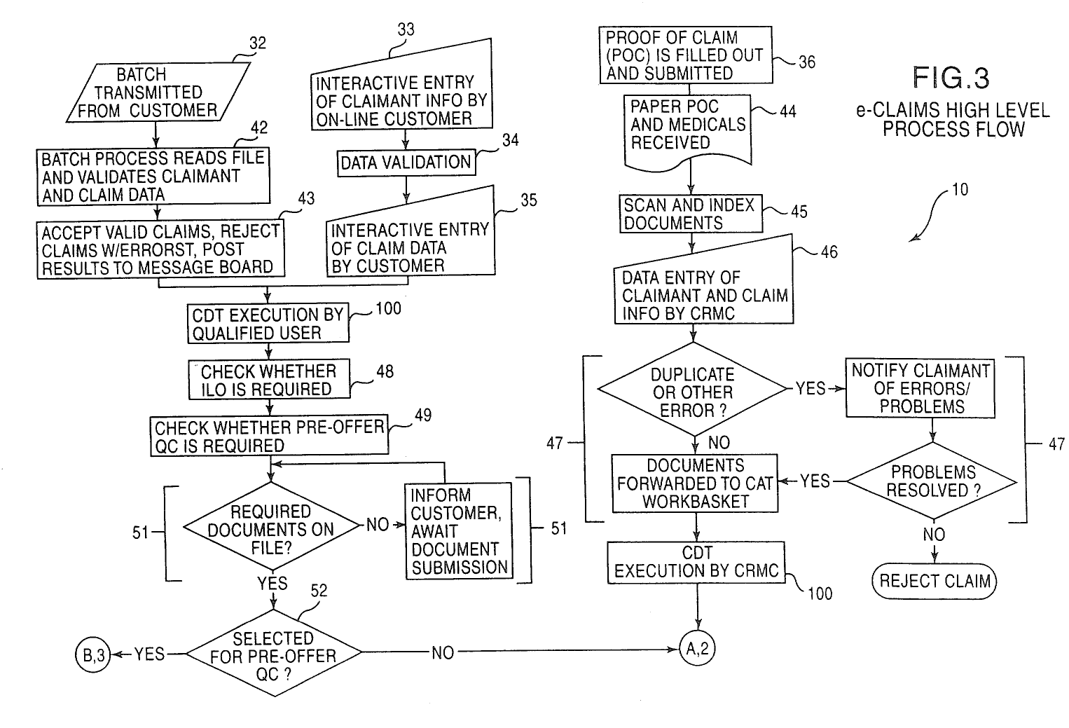

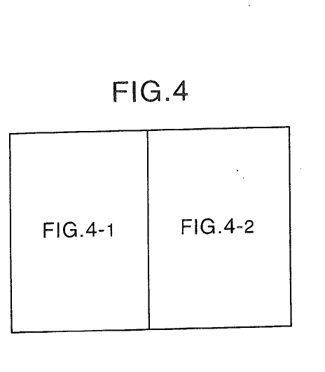

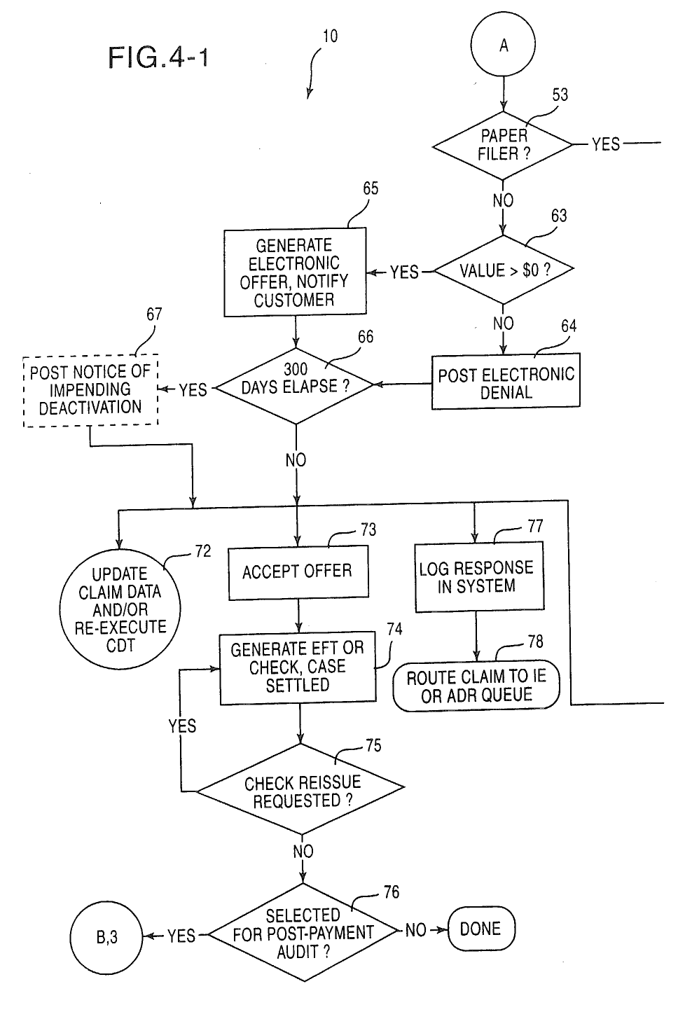

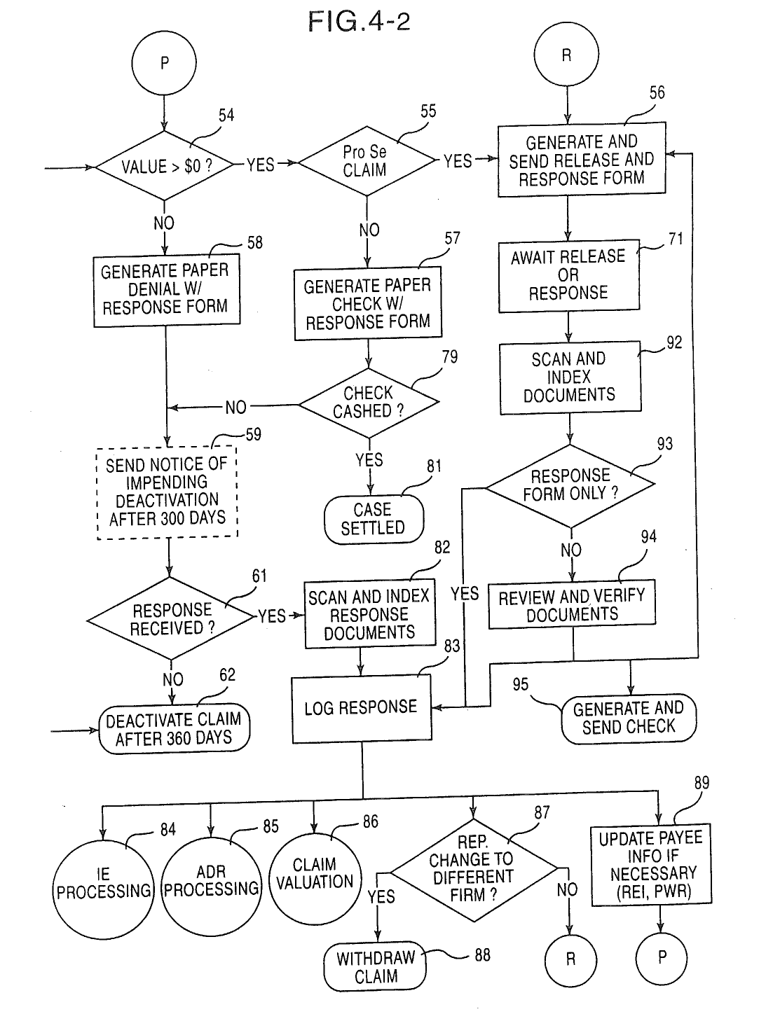

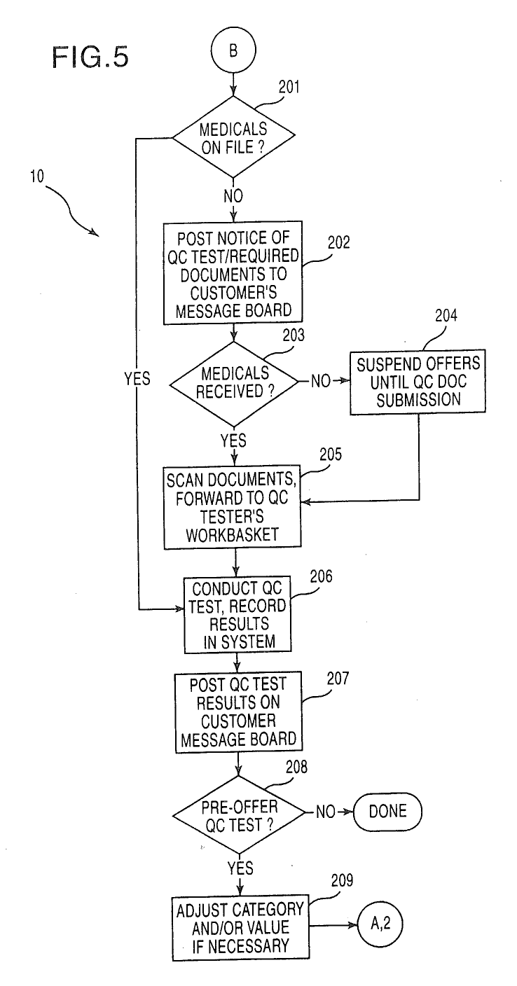

A detailed flow diagram for the exemplary claim process 10 is illustrated FIGS. 3-5. Blocks 32-36 illustrate portions of the submission process 30 shown in FIG. 2. Block 32 represents transmitting a batch file from the customer to the claim processor, or claim processing system 10. Blocks 33-35 are utilized in the interactive data entry for a web-based system. The filling out and submission of a paper claim is represented by block 36.

Block 33 represents the entry of the claimant demographic information 12 into a web-based form. Examples of demographic information include: claimant identification and contact information; attorney identification and contact information; litigation history; exposure history; injury and/or related health history (for example smoking history). The actual demographic information requested/required may depend on the type of claim being made/filed. Consequently, the information requested/required for an asbestos claim may differ from the information requested/required for a medical insurance claim.

Examples of claimant identification information include: full name (legal name); social security number; gender; date of birth; date of death; and/or personal representative name.

Examples of claimant contact information for a living claimant include: mailing address, phone number(s), and/or email address. If the claimant is deceased, similar contact information may be requested for the claimant's personal representative.

Examples of attorney identification and contact information include: law firm name; law firm code; docket number; responsible attorney; law firm tax identification number; phone number(s) (voice and/or facsimile); mailing address, and/or email address(es).

Examples of litigation information include: date filed; state filed; court docket number; name and address of the court, and/or attorney name and address handling the case.

Examples of exposure information include: dates of exposure; occupation; industry; exposure site code; employer; union; exposure site, exposure address; exposure location; and/or product exposed to. This information may be used and/or requested with proof of claim information 14. In some embodiments the exposure information may be the proof of claim information.

Examples of health related information include: pre-existing injuries; allergies; hospitalizations; smoking history (smoked ever, current smoker, date quit, etc); and/or drinking history (how many times a week, etc.).

In the current embodiment, the data is validated by the user at block 34. At block 35, the customer and/or claimant interactively enter proof of claim data 14. An example of such claim data includes, information from medical records and/or other reports. In some embodiments, block 35 may be performed while executing the CDT 100.

When batch file transmission is utilized, the batch file is read and the data validated in block 42. Thereafter, valid claims may be accepted, claims with errors are rejected, and the results of the validation are posted to an electronic message board for download or review by the customer in block 43.

Thereafter, the program flow from either the batch entry method and/or the web-based entry moves to the categorization decision tree 100 to place a value on the entered claim. In the interactive embodiment, a customer, user, and/or claimant answers questions that are used by the categorization decision tree to determine the value of the entered claim. When utilizing the interactive mode of claim submission, the data entry to support the categorization decision tree process 100 may be performed while the customer is on-line. For batch data entry, the execution of the categorization decision tree 100 may be done either offline as part of submitting the claim, or on line after the batch file has been uploaded from the customer to the claim processor, and/or claim processing system 10.

In block 48, the process may determine if specific medical documentation is required for the submitted claim. In the example illustrated in FIG. 3, the process 10 determines if an ILO is required. In some embodiments, the claim process may determine if a pre-offer quality control check (QC) is required/desired for this particular claim in block 49. As discussed above, a pre-offer QC may be accomplished on a random basis, or on the basis of region and/or law firm, and/or other criteria determined by the claim processor. In block 51, the process may verify that all documentation required to substantiate the claim is on file. This documentation may include medical reports, X-rays, and for asbestos related cases an ILO. If a pre-offer QC is required, then the program flow may move in block 52 to the quality control segment that begins with block 201. Alternatively, the program flow may join the process flow utilized for paper filers at block 53.

When an electronic claim is filed using the claim processing system 10, the process flow moves from decision block 53 to decision block 63 where the claim value is checked. If the claim value is zero, a denial is posted electronically in block 64. When the claim has a value greater than zero, an electronic offer may be generated and posted to the customer in block 65. This posting may include posting to a message board, sending an e-mail, or providing a web page for the user to view. Alternatively, a paper letter may be generated and mailed to the customer and/or claimant.

Thereafter, decision block 66 may check to see if 300 days have elapsed since the offer was made. Once 300 days have elapsed, a notice of impending deactivation may be provided to the user, customer, and/or claimant in block 67. The process flow may move to block 62 to deactivate the claim after 360 days. When the user chooses to update claim data and/or re-execute the categorization decision tree 100, the process flow moves to block 72. Alternatively, the user's response may be logged in block 77, and the claim routed to individual examination or alternative dispute resolution in block 78. When the user elects to accept the offer in block 73, payment is generated in block 74 by generating an electronic funds transfer, and/or by a paper check. Once payment is generated, the case is considered settled. In some embodiments, it may be desirable to provide the customer the ability to request a re-issued check, in the event that the payment data is incorrect in block 75. Thereafter, a corrected check or electronic funds transfer will be generated using block 74. The claim may be considered for a post-payment audit in block 76. If no post-payment audit is going to be conducted, the claim process terminates. When an audit is performed, the process moves to block 201 to perform the audit process.

The quality control process begins with decision block 201 where the process flow checks to see if the required proof of claim and/or medical documentation is on file. If the required documentation is on file, then the process flow moves to block 206. In the event that the medical and/or proof of claim 14 documentation is not on file in block 201, the flow may move to block 202 where the customer is notified that the required documentation has not been received. This notification may be done using paper mail, electronic mail, a message board or some other communication method.

Thereafter, the process flow moves to decision block 203, which checks for the receipt of the missing documents/information. In some embodiments, the process flow may suspend offers on other claims submitted by the particular customer, until the required documents have been submitted using block 204. After receipt, the documentation may be scanned and forwarded to a quality control tester in block 205. In block 206, a quality control test may be performed and the results recorded.

The customer may be notified of the quality control test result in block 207. These test results may be communicated to the customer using e-mail, paper mail, telephone, facsimile, message board and any other communication system. In some embodiments, the process may check to see if the quality control test was done before the offer was made in block 208. When the quality control test was done before the offer, the process flow may move to block 209 to adjust the categorization and/or value of the settlement offer, if necessary. Thereafter, the flow returns to block 53, and the process continues from that point, as discussed in detail above.

For paper claims, the analysis and valuation of the claim begins after receiving the paper medical documents and claim forms in block 44. In some embodiments, these documents may be scanned and indexed in block 45. Thereafter, the information from the paper documents may be entered into a computer system in block 46. This data entry includes, at least, the claimant's demographic information 12. The data entry referred to in block 46 may include, but is not limited to data entry by a human operator or performing optical character recognition on the document scanned and indexed in block 45. If optical character recognition is utilized, then the quality of the optical character recognition may also be tested and/or checked. In some embodiments, the process and/or program may check for duplicate claims or other errors in the claim, as entered in the computer system, in block 47.

In the case of a claim filed by paper, an individual at the claim processor may execute the categorization decision tree 100. Alternatively, the CDT may process the claim based on the data entered into the system in block 46. Thereafter, the process flow moves to decision block 53 where the process checks to see if the claim was filed by paper or through electronic means.

If the claim was filed on paper, then the claim process may move to decision block 54, which checks to see if the claim value was greater than zero. In the event that the claim value was zero, a denial letter and/or response form may be generated in block 59 and sent to the customer or claimant. If no response is received after 300 days, it is preferred but not required that a notice of deactivation be sent in block 59. If a response is received in block 61, the documents may be scanned and indexed in block 82, and the response logged in block 83. If no response was received at block 61, the claim may be deactivated after 360 days.

When the claim value is greater than zero in block 54, the process flow moves to block 55. For claims filed by a customer law firm in block 55, the process moves to block 57 where a paper check and response form are generated. Thereafter, if the check is cashed in block 79, the case will be considered settled in block 81. If the check is not cashed, then the process flow moves to block 59 discussed above.

If the claim was filed by the claimant or other individual on behalf of the claimant (a pro se claim), a release and response form may be generated in block 56. Thereafter, the process awaits receipt of the release or response form in block 91. The received documents may be scanned and indexed in block 92. If only a response form is received in block 93, the process flow moves to block 83 and the response is logged. If the response includes the release, in block 93, then the documents transmitted are reviewed and verified in block 94. Thereafter, if all the documents were properly executed, a check may be generated and sent in block 95, and the response logged in block 83. When there are discrepancies with the documents, the process flow may return to block 56, and generate a second release and response form.

After the response was logged, the process flow may move to individual examination processing in block 84, ADR processing in block 85, or claim valuation in block 86 depending on the claimants response. If the representation of the claimant changes to a different firm in block 87, then the claim will be withdrawn in block 88. If the representation did not change, then the process may return to block 56 to generate, and transmit a release and response form. Alternatively, in block 89, if necessary, the payee information may be updated, and the process may then return to block 54 for processing consistent with the process discussed above.

Categorization Decision Tree

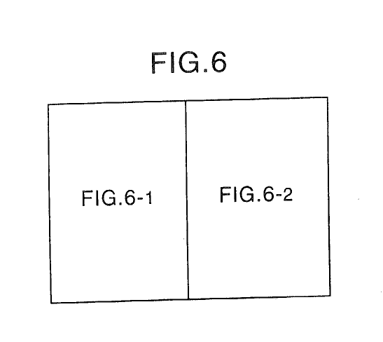

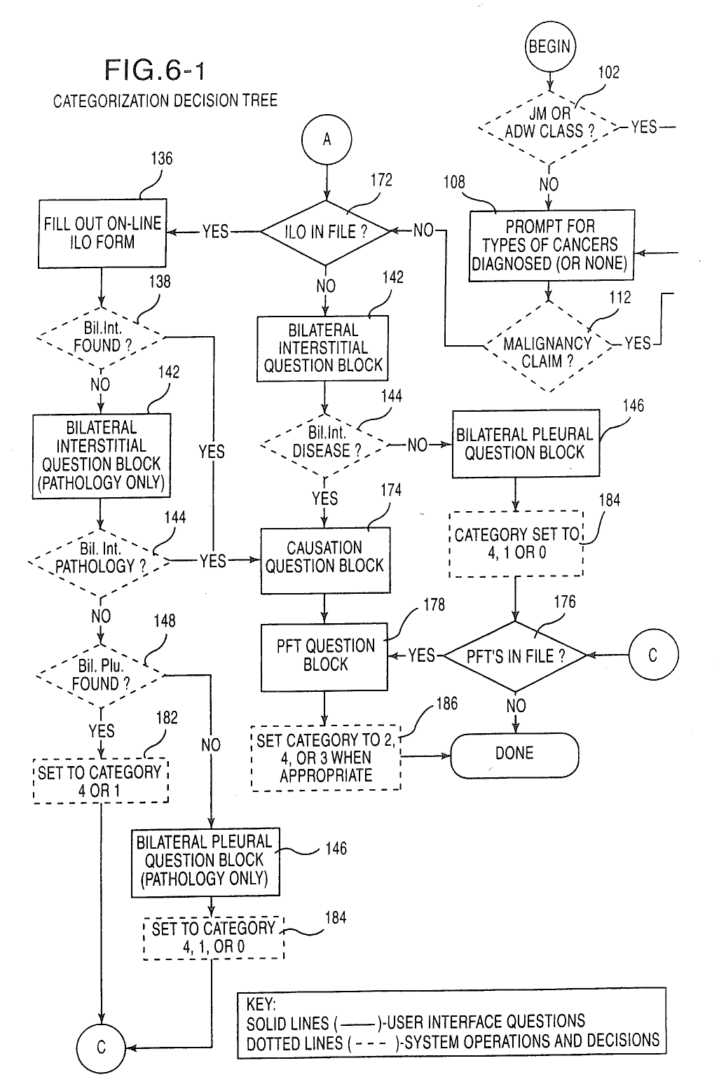

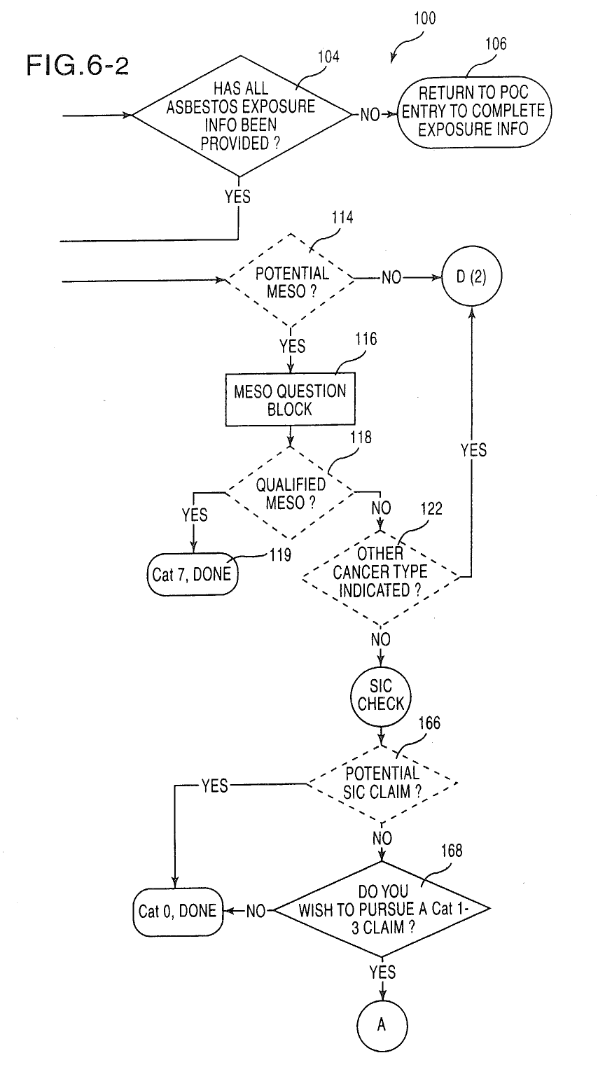

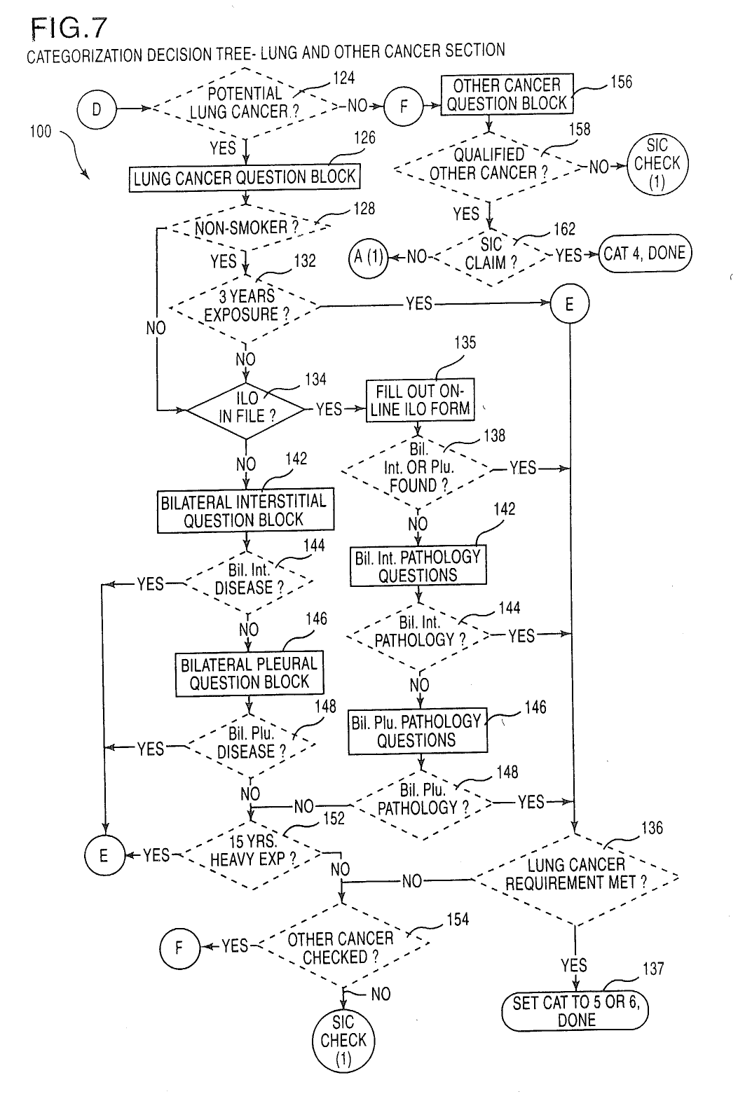

FIGS. 6 and 7 illustrate an exemplary categorization decision tree (CDT) 100 that may be utilized in determining the settlement value of a claim against the Manville Personal Injury Trust. Consequently, the illustrated CDT is constrained by and must implement the requirements of the Trust Distribution Process approved by the Court. In other embodiments, the categorization decision tree 100 may be based on the requirements imposed by an insurance company, court, or by the parties in a settlement agreement.

As an alternative to the CDT 100, an expert system may be tailored to the requirements imposed by an insurance company, a court, and/or any other agreed upon claim resolution process.

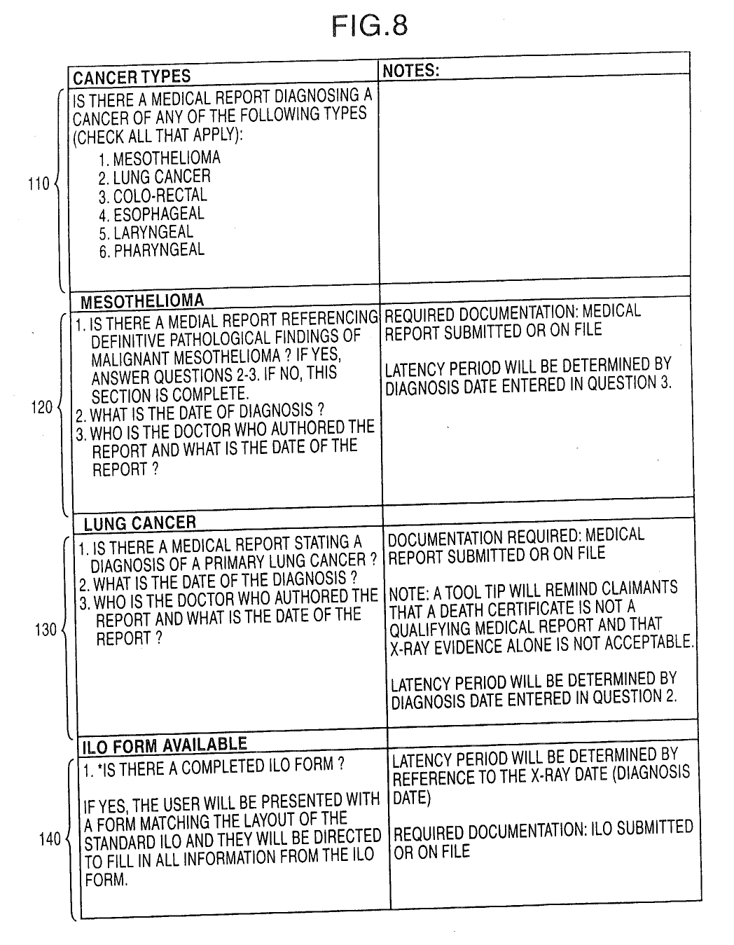

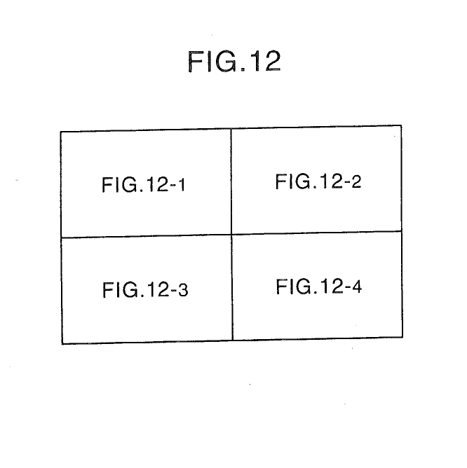

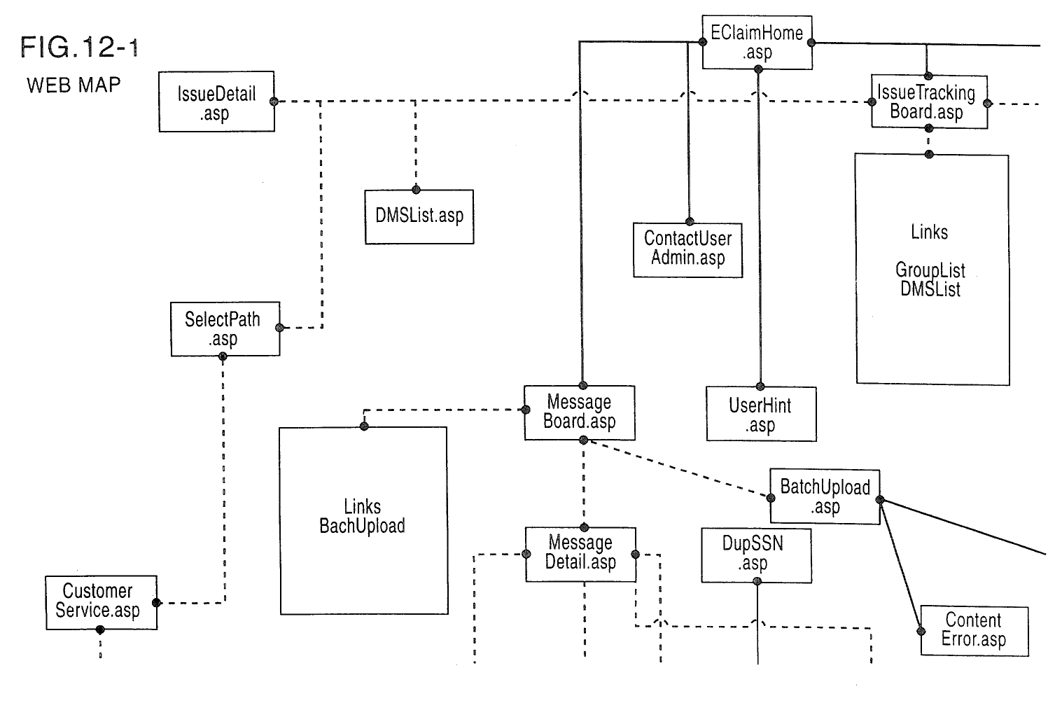

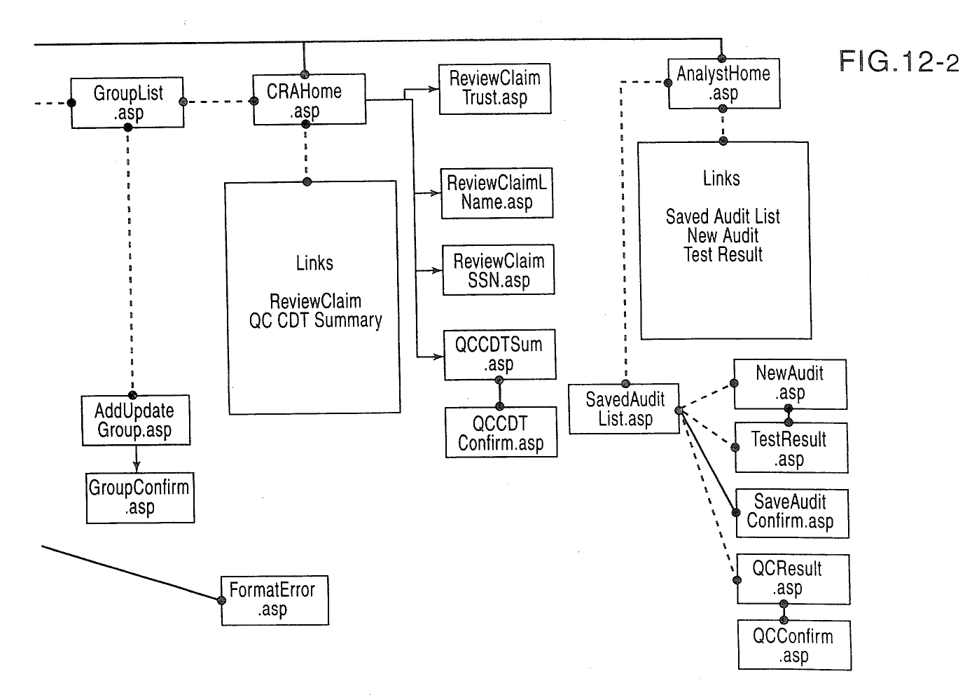

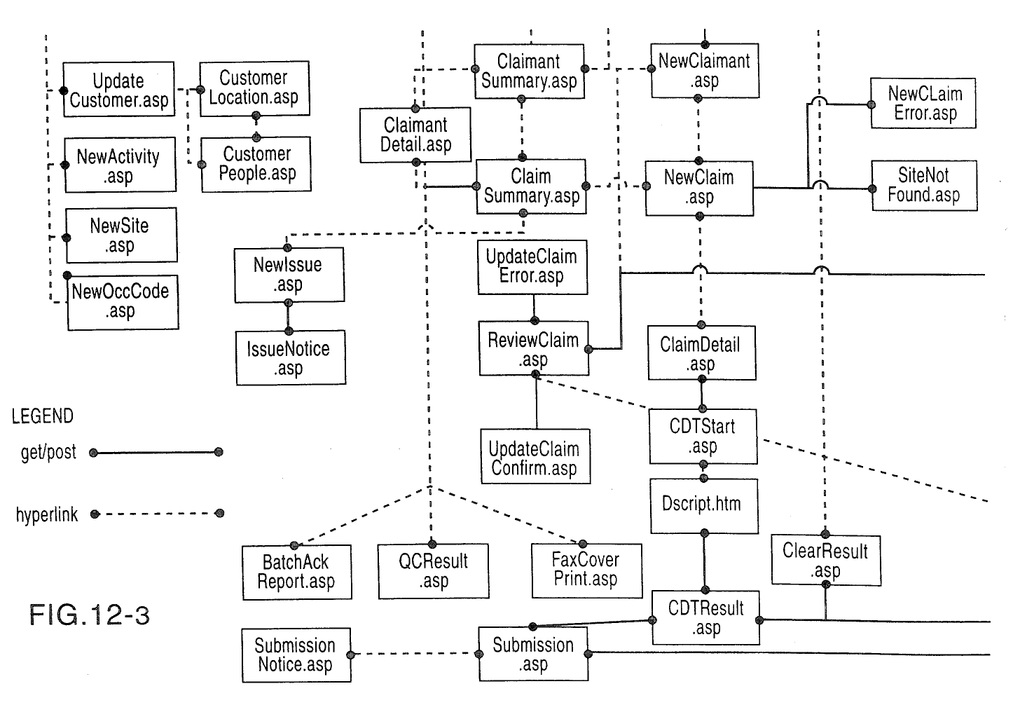

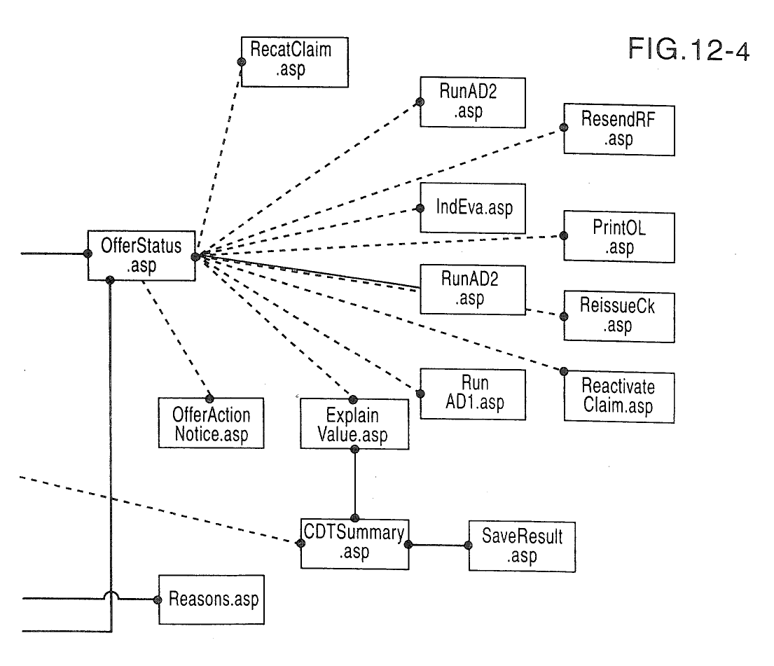

The embodiment shown in FIGS. 6-7 and the questions illustrated in FIGS. 8-12 illustrate one example of a CDT specifically tailored to the determination and valuation of asbestos claims. Other entities and other trusts may utilize a CDT tailored to their specific requirements. It is within the ordinary skill in the art to develop and program a categorization decision tree 100, or an expert system applicable to other claim processes based on the example provided herein.

The categorization decision tree 100 may provide an outline for asking several different groups of questions. In the current embodiment, the questions begin with general questions. Specific questions are then used to define the extent of the claimant's injury (damage) and the corresponding claim value. In some embodiments the answers provided to the previous questions would determine the next set of questions. Additionally, in some embodiments, the questions and their answers may be used to determine the required proof of claim documentation 14.

In decision block 102, the CDT 100 illustrated in FIGS. 6 and 7 determines if the exposure information previously entered supports a “Manville Only” or “Australian Dock Worker” classification. When the exposure information previously entered supports a “Manville Only” or “Australian Dock Worker” classification, the CDT 100 may show the user all exposure data previously entered. After displaying the exposure information, the user may be required to confirm that all of the claimant's exposure to asbestos products has been entered. If the user responds in the negative, decision block 104 may direct the user to the demographic/exposure data entry screens to complete the information. This data entry is represented by block 106.

Question block 110 (FIG. 8) may be displayed in block 108 when the exposure information previously entered does not support a “Manville Only” or “Australian Dock Worker” classification in decision block 102 or the user responds in the affirmative after reviewing the displayed exposure data at decision block 104. Question block 110 requests the type of cancer diagnosed in the claimant.

When at least one cancer is selected in block 108, decision block 112 directs the process flow to decision block 114. In this block, the process determines if a specific cancer (in the example illustrated—mesothelioma) was selected in block 108. If mesothelioma was selected, then decision block 114 would cause the mesothelioma question block 120 to be displayed in block 116. After the user answers the questions displayed in block 116, the process determines in block 118 if the claimant qualifies for a category 7 settlement. When the claimant qualifies for category 7, the process terminates and the claim is assigned the settlement value associated with a category 7 claim in block 119.

When the claimant is not qualified for a category 7 settlement, the process checks for other cancer types in block 122. If the answers to previous questions indicate that a cancer other than mesothelioma was diagnosed, then the CDT process 100 moves to decision block 124. For this block, the previously submitted answers are checked to determine the presence of lung cancer.

When lung cancer has been diagnosed, the lung cancer question block 130 (FIG. 8) may be displayed in block 126. Decision blocks 128 and 132 may direct the process flow to either decision block 136 where the process determines if all the requirements for lung cancer are met or to decision block 134 where the process checks to see if an ILO is in the file. The process flow depends on the answers to the questions asked during the CDT process 100, the demographic information 12, and/or proof of claim in information 14. When all the requirements for lung cancer are met the claim is valued as either a category 5 or 6 claim depending on the circumstances in block 137.

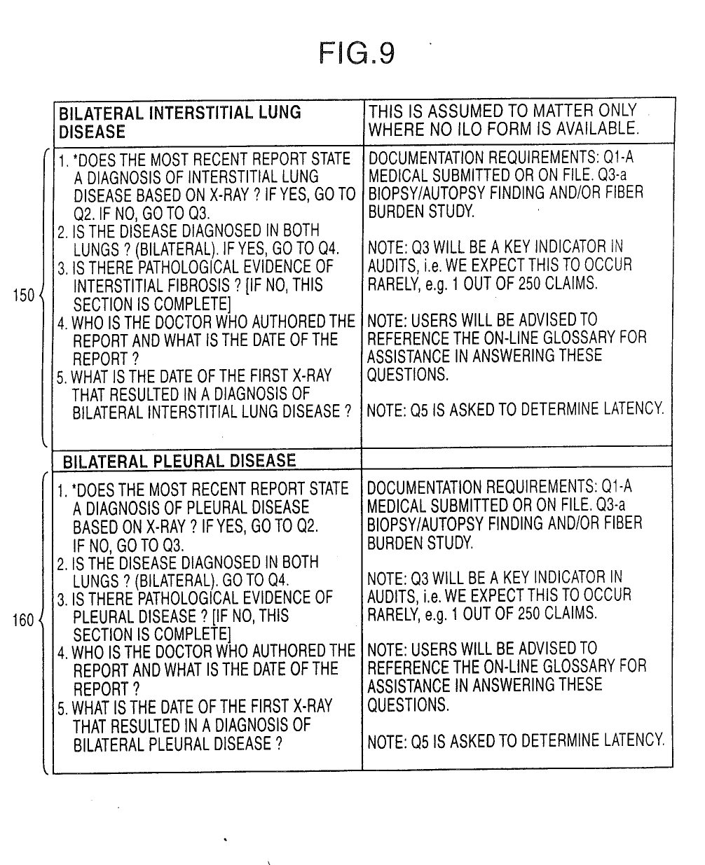

When an ILO is in the file at decision block 134, the CDT process 100 moves to block 135. In this block, the user enters the data from the ILO. Based on the CDT answers and claimant data (demographic and etc.), a determination of either bilateral interstitial or bilateral pleural lung disease is made in block 138. The CDT process 100 then moves to decision block 136 (discussed above). When a determination of either bilateral interstitial or bilateral pleural lung disease cannot be made with the available information, the CDT process 100 may display the bilateral interstitial lung disease question block 150 (FIG. 9) in block 142. Next, the CDT process 100 checks to see if the claimant meets the requirements for bilateral interstitial lung disease in decision block 144. When the requirements are met, the CDT process moves to decision block 136 (discussed above). If the requirements are not met, the CDT process may display the bilateral pleural lung disease question block 160 (FIG. 9) in block 146. Thereafter, the CDT process checks to see if the claimant meets the requirements for bilateral pleural lung disease in decision block 148.

When the requirements for bilateral pleural lung disease are met, the CDT process 100 moves to decision block 136 (discussed above). If the requirements are not met, the CDT process may move to decision block 152. Here the CDT process determines if the claimant was subject to fifteen years of heavy exposure. When the claimant was subject to fifteen years of heavy exposure, the CDT process moves to decision block 136 (discussed above).

If the claimant was not subject to fifteen years of heavy exposure, or decision block 136 determines that the requirements for a lung cancer determination are not met, the CDT process moves to decision block 154. Block 154 checks for other cancers in the claimant's data. Typically, this is accomplished by looking at the answers to question block 110 (FIG. 8) entered in block 108.

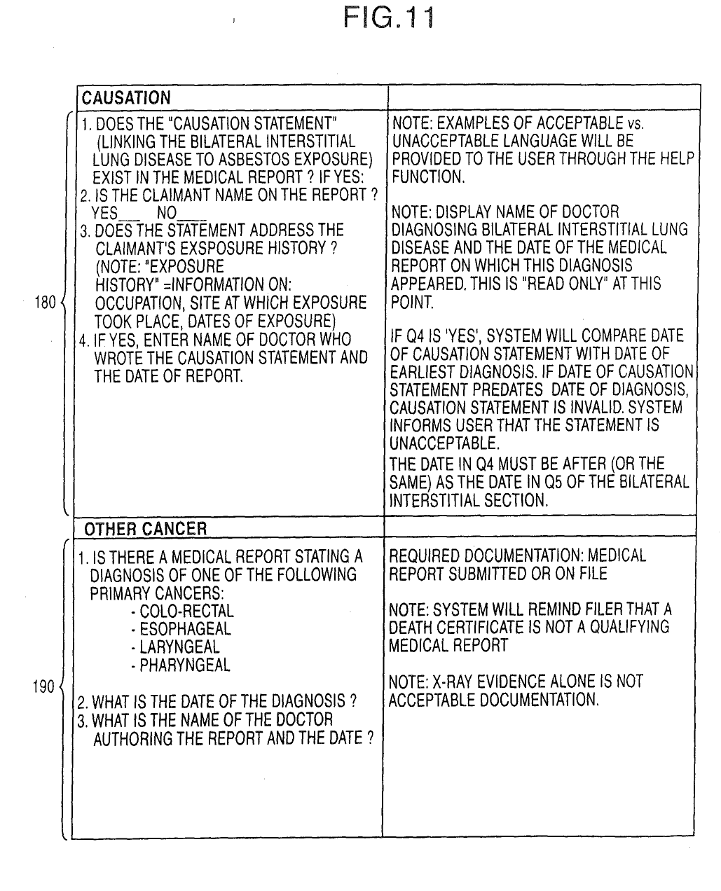

When the CDT process determines that other cancers were indicated, the CDT process 100 displays the other cancer question block 190 (FIG. 11) in block 156. Thereafter, the CDT process may determine if the claimant has a qualified other cancer in decision block 158. When the claimant has another qualified cancer, the CDT process checks for a valid Standard Industrial Classification (SIC) claim in decision block 162. If the claim is a valid SIC claim, then the claim is valued as a category 4 claim.

When the claimant, based on the information entered, does not have another qualified cancer in decision block 158, then the CDT process 100 may perform an SIC check by moving to decision block 166. The CDT process determines if the claimant has a potential SIC claim in block 166. When there is not a potential SIC claim, then the CDT process moves to decision block 168. In this block, the user can elect to pursue a claim in categories 1-3. When the user determines that a claim in categories 1-3 will not be pursued in decision block 168, or there is a potential SIC claim in decision block 166, then the claim is valued as a category 0 claim or is denied.

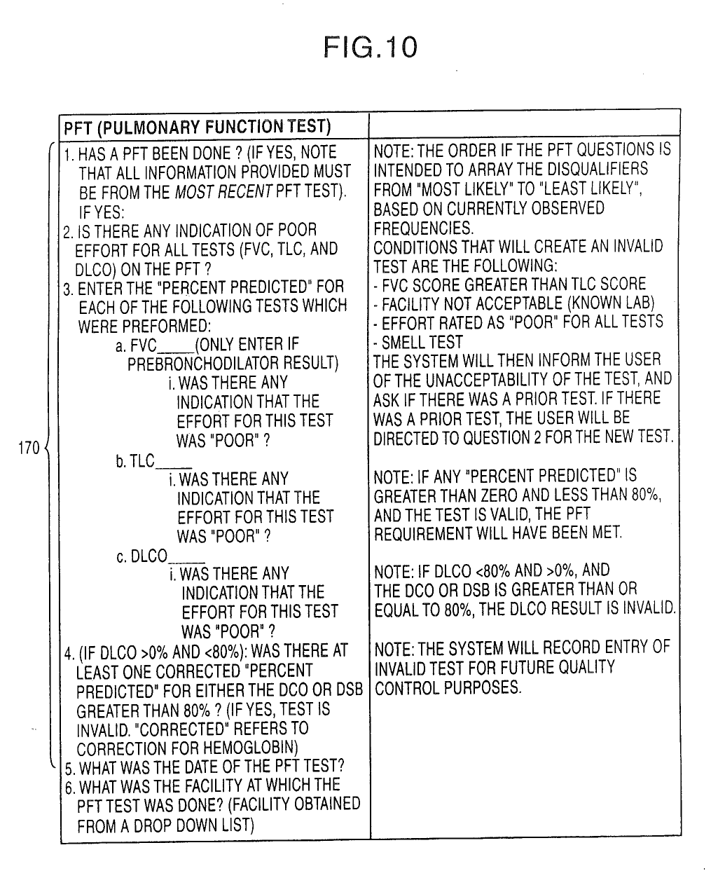

If the claim is not a SIC claim in decision block 162, the user elects to pursue a category 1-3 claim in block 168, or the claimant did not have a diagnosed cancer in decision block 112, then the CDT process 100 moves to decision block 172. In block 172, the user enters whether or not an ILO is in the file. When an ILO is on file, the CDT process performs blocks 136, 138, 142, and 144 (as discussed above). However, if bilateral interstitial lung disease is found in either decision block 138 or 144, the CDT process may display the causation question block 180 (FIG. 11) in block 174. In the current embodiment, block 174 is followed by block 178. In block 178, the Pulmonary Function Test (PFT) question block 170 (FIG. 10) is displayed.

If bilateral interstitial lung disease is not found in decision block 144, the CDT process 100 moves to decision block 148 when an ILO is on file. Alternatively, the CDT process moves to block 146. Blocks 146 and 148 were previously discussed. When bilateral pleural lung disease is not found in decision block 148, the CDT process moves to block 146. Thereafter, the CDT process sets the appropriate claim category in blocks 182 and 184. When an ILO is not on file, the CDT process 100 may then ask the user if a PFT was on file in decision block 176. When a PFT is on file, the CDT process moves to block 178 discussed above. Depending on the claimant information obtained, the CDT process categorizes the claim in block 186. When a PFT was not on file in block 176, block 184 would provide the final categorization for the claim. Web Deployment

When providing a web based or web enabled claim process system 10, it is desired, but not required, to have a secure web site. In order to protect the data integrity, it is preferred that the web site provide security similar to that provided for internet credit card transactions. To protect the claimants' privacy, it is desired that the user login using a username and password. It is also desirable that an authorized user only have access to the records associated with a particular username, or associated with a particular group of usernames. A group of usernames could represent a group of individuals at a particular customer. One example of such a group is the users at a law firm.

In the current embodiment, the user would be provided with a menu or link structure. This structure would permit the user to navigate to the information and/or particular web page desired.

One of these pages could display a claim form, where the user could enter the demographic 12 and/or proof of claim 14 information. Typically, the on-line form would request information similar to the information requested in the paper claim form. In the current preferred embodiment, the paper and electronic forms have a similar structure to speed the transition to electronic and/or web based claim submission. Other pages may display: customer message board(s); claim status; claim details; CDT results; CDT summary; and/or offer status.

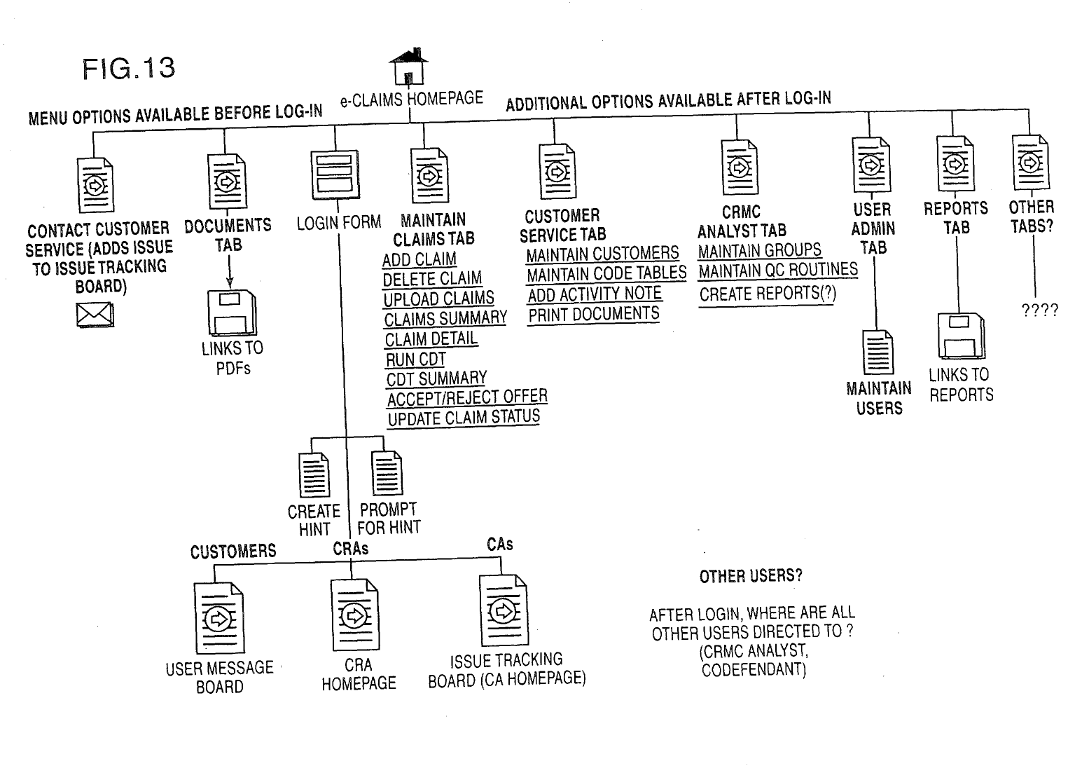

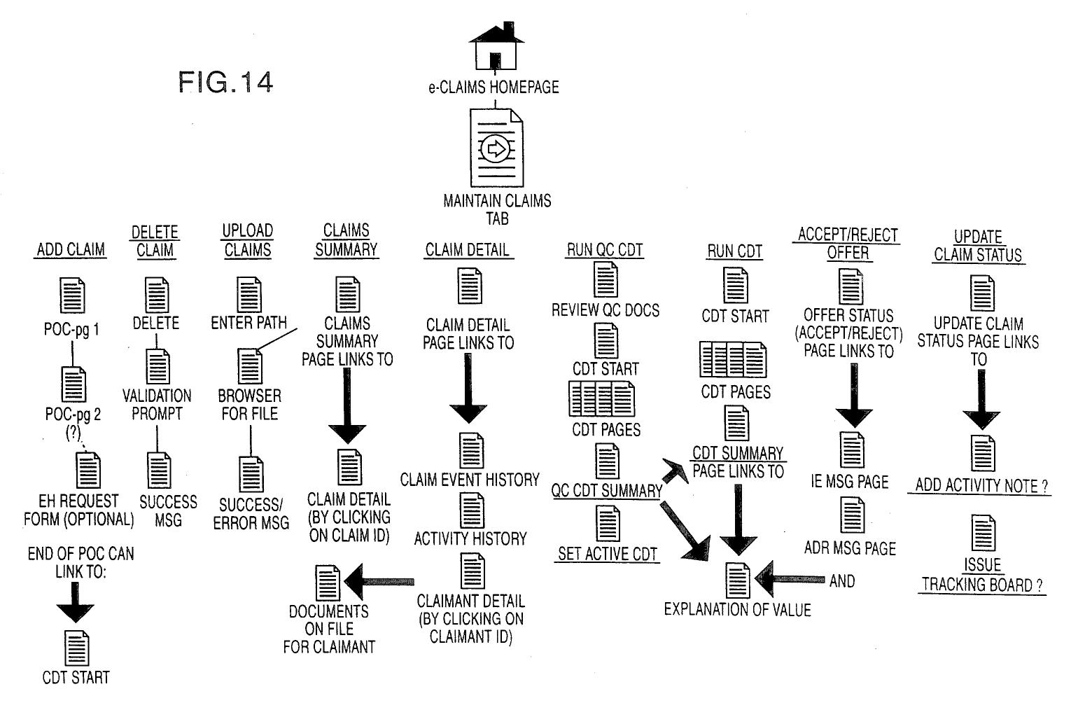

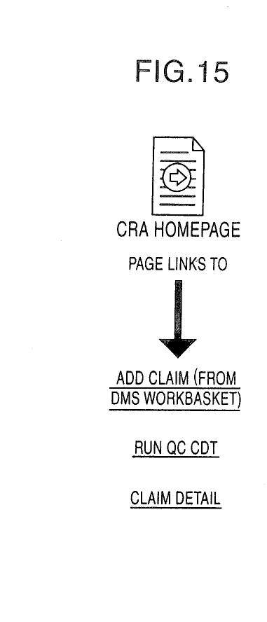

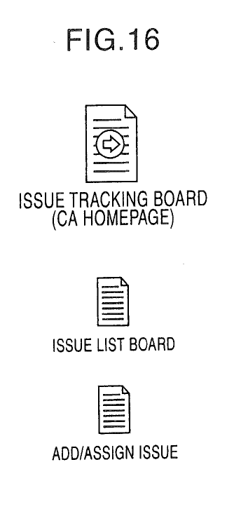

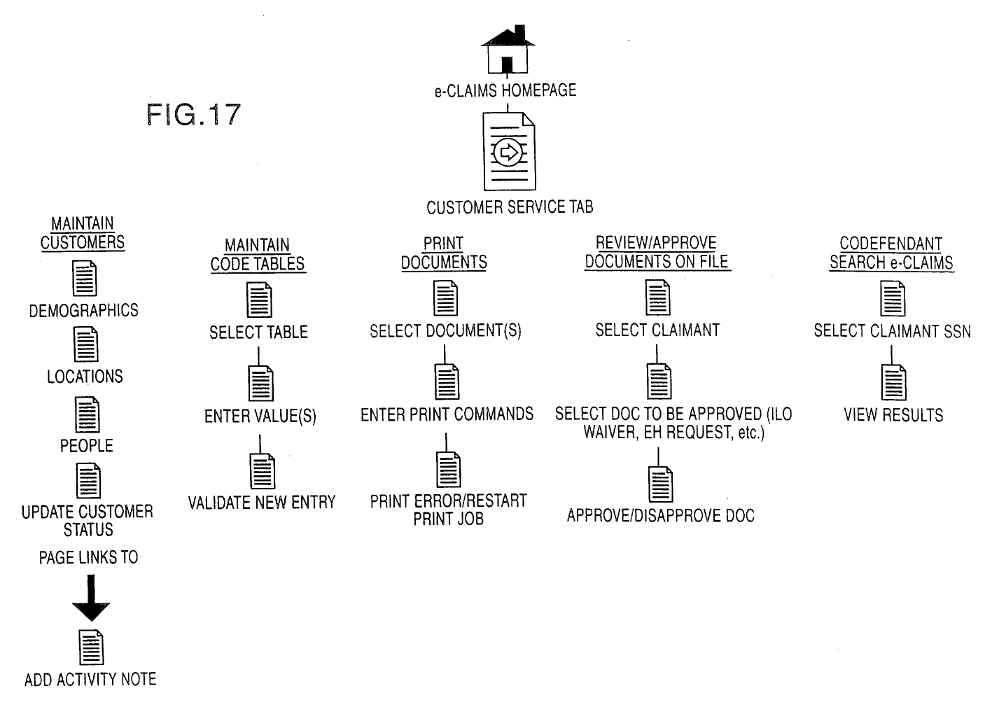

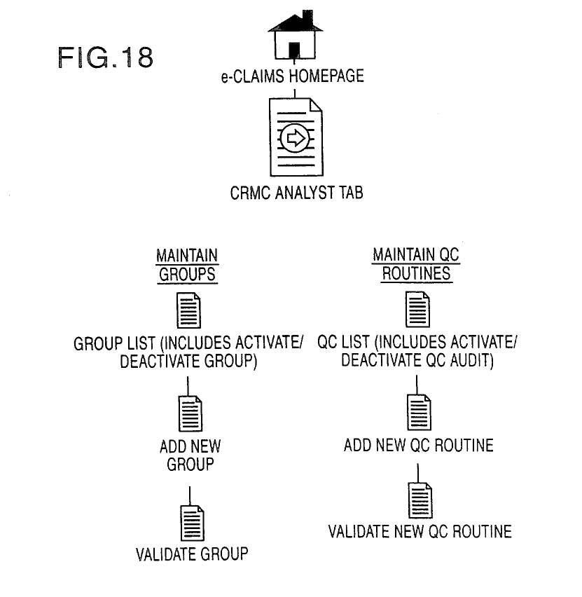

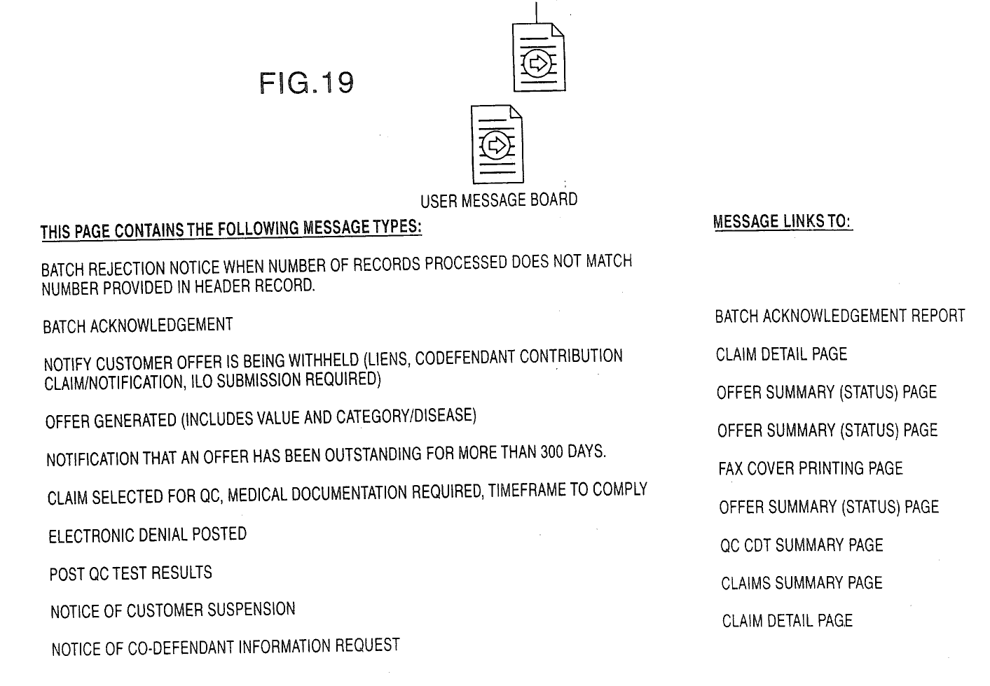

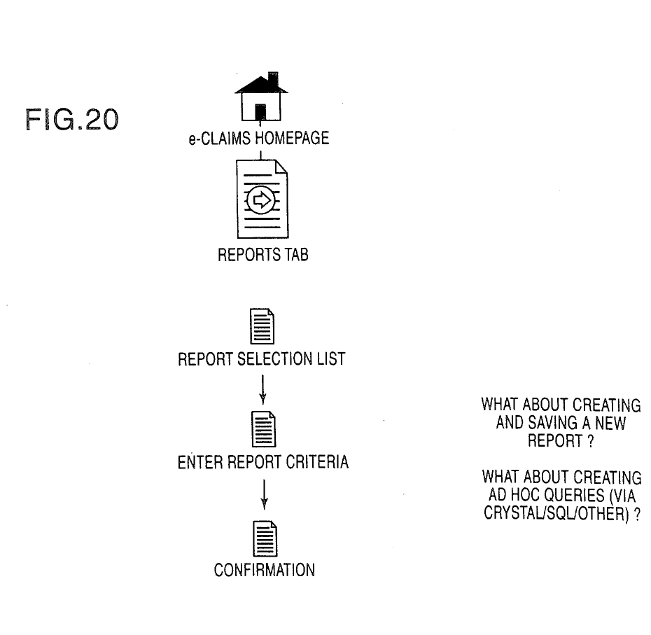

FIGS. 12, and 12-1 to 12-4 provide a map of an exemplary web site on which claim process 10 may be deployed. These figures illustrate the connections (for example, hyperlinks and get/post) between the active server pages used in the current embodiment. FIGS. 13-20 illustrate the menu structure employed in the current embodiment. One of ordinary skill in the art would readily understand that a web site for claim processing could and typically may have a different map and or connection structure. This map depends on the type of claim processing performed at the website. Furthermore, it is expected that different web sites may utilize a different menu structure and still provide the claim processing capability described above. These Figures are provided in order to disclose the current embodiment.

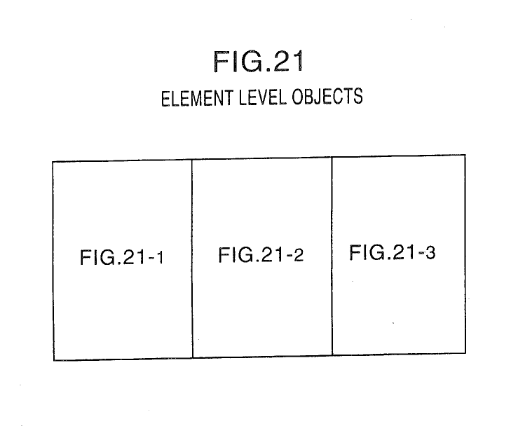

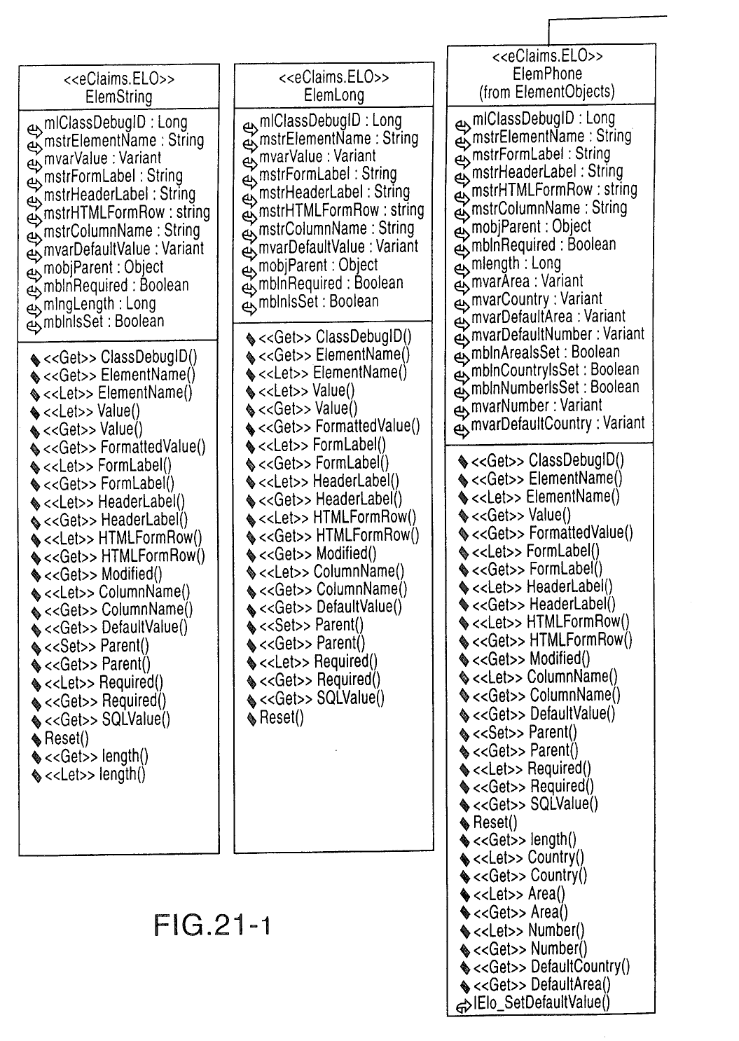

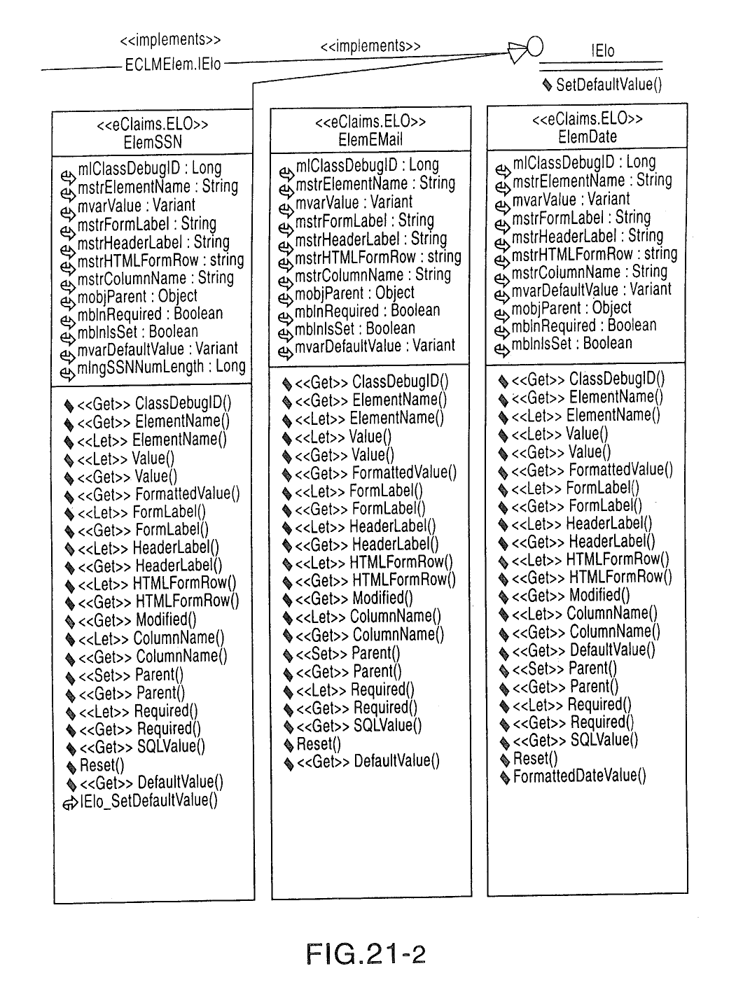

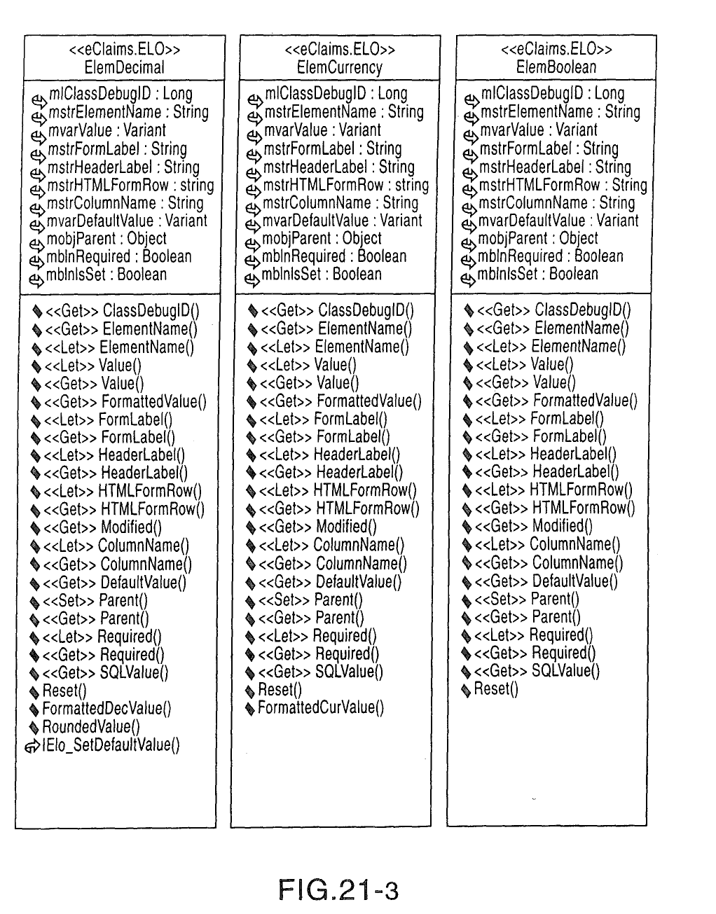

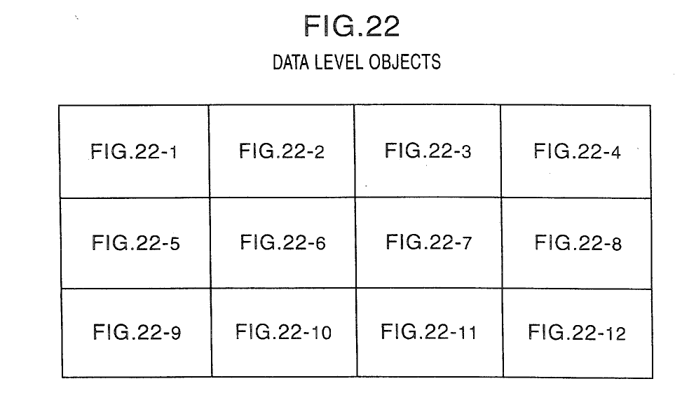

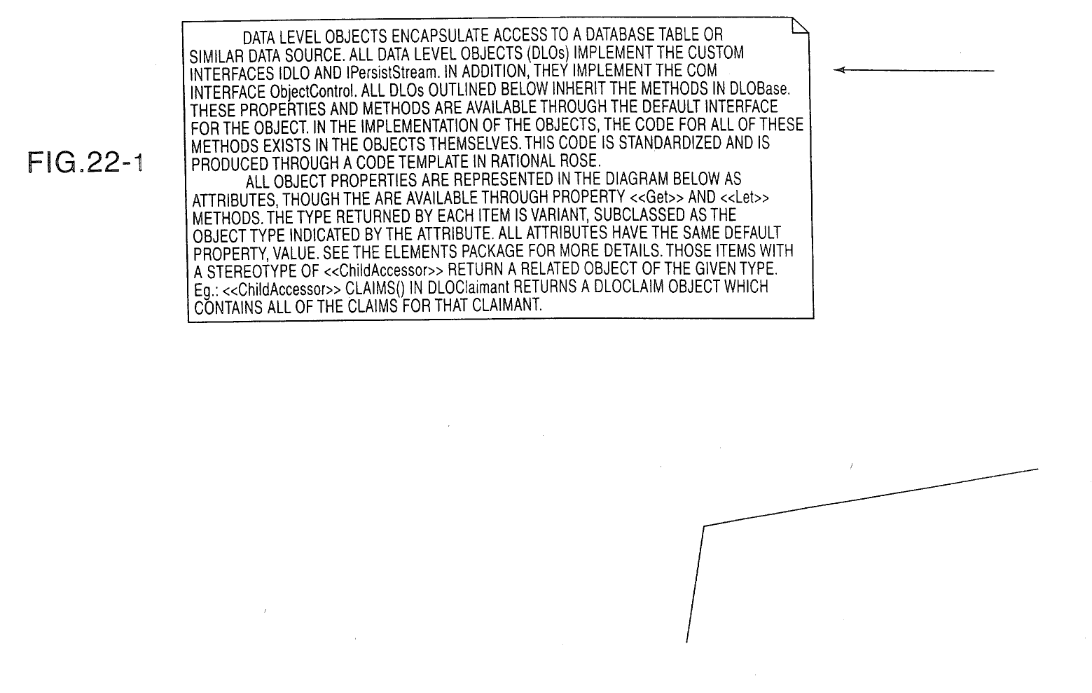

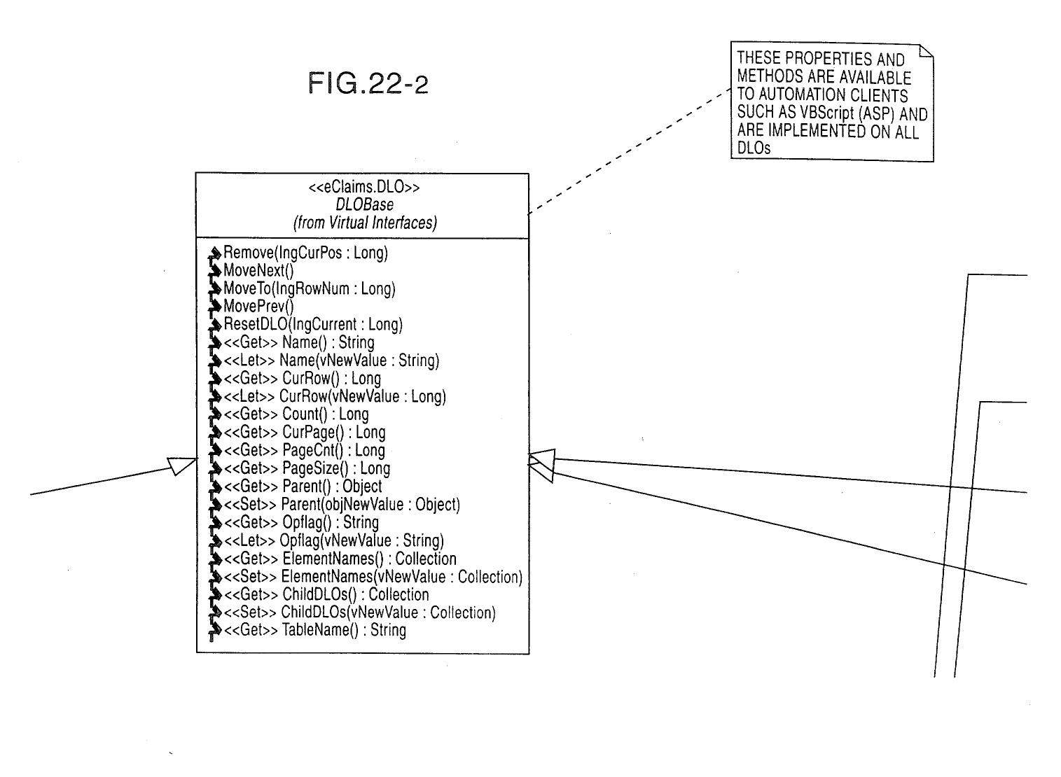

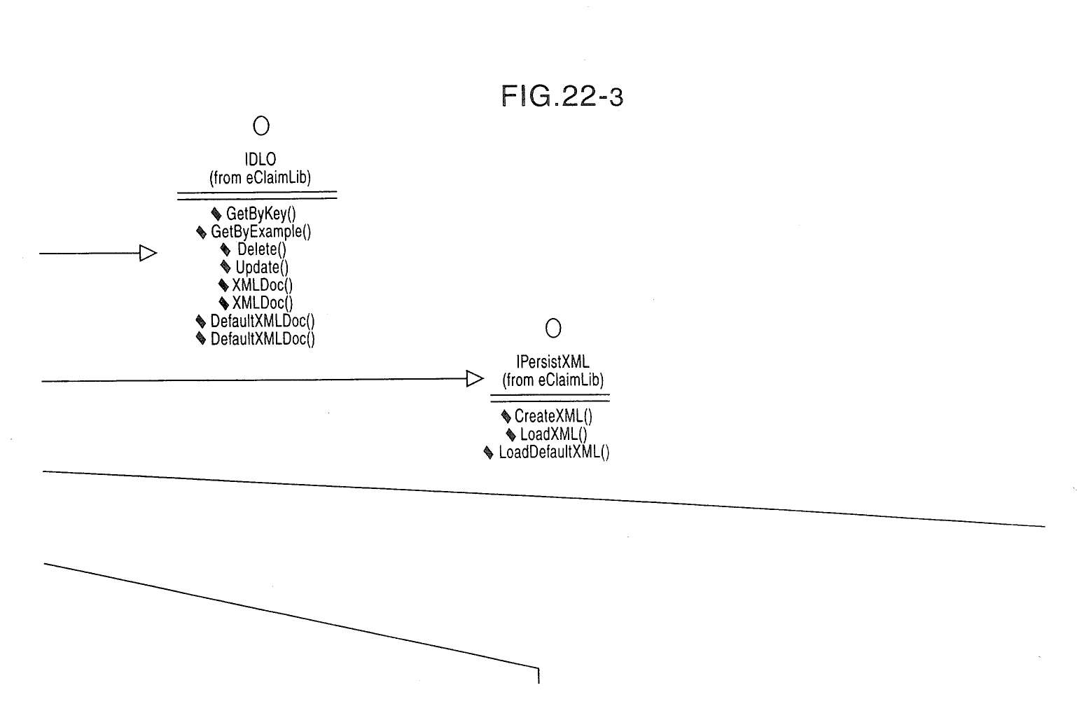

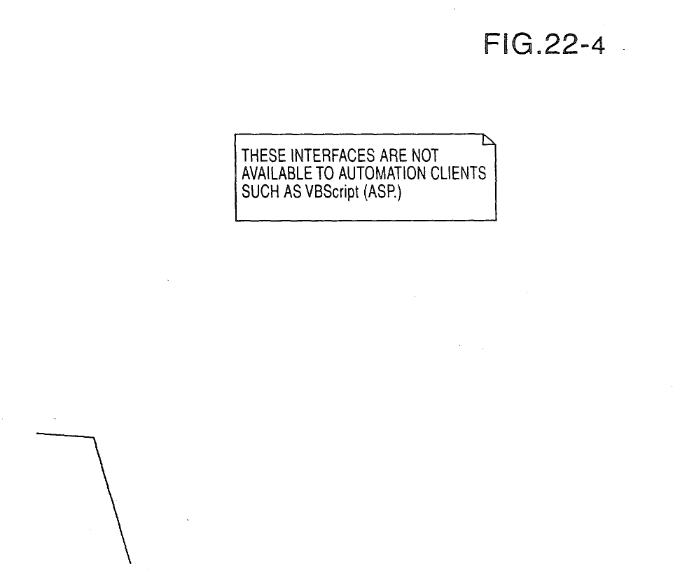

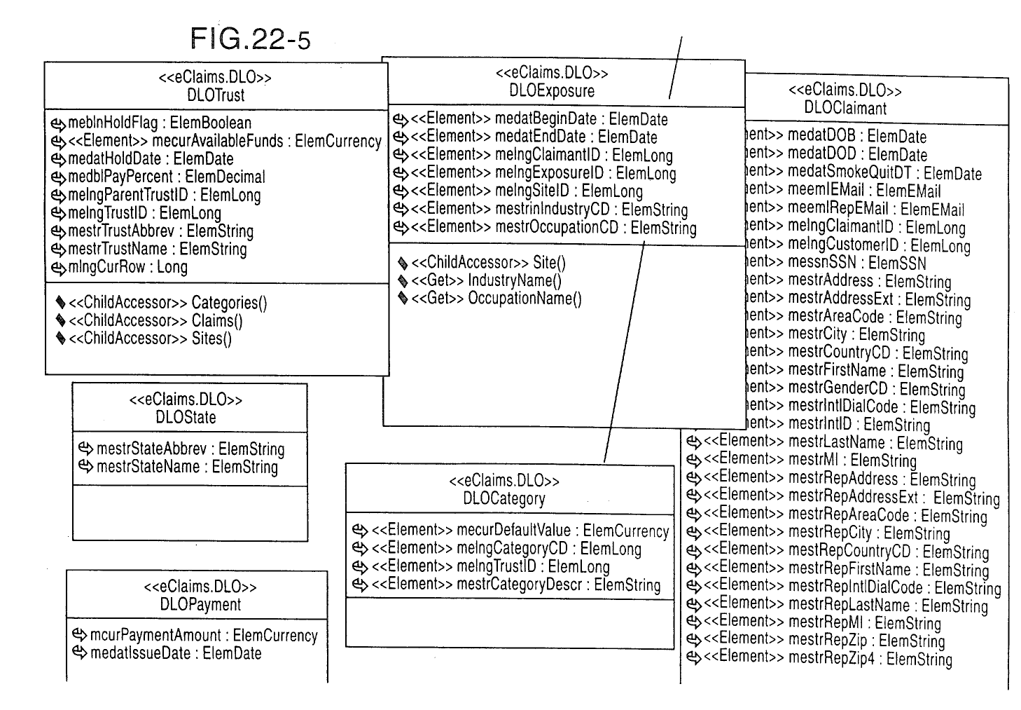

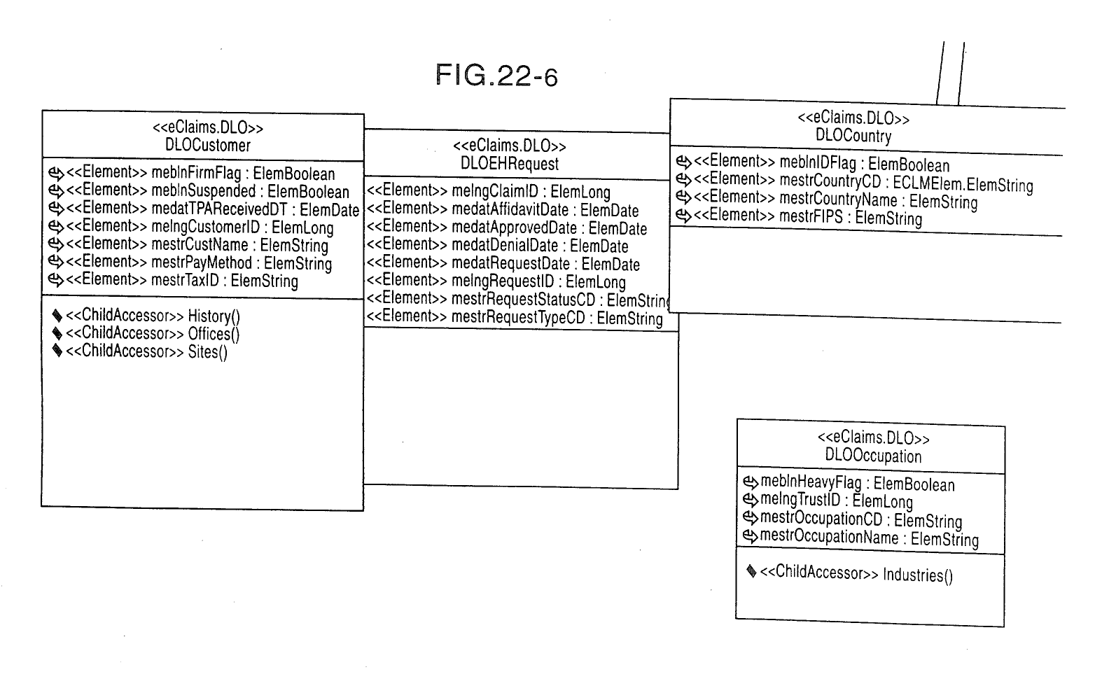

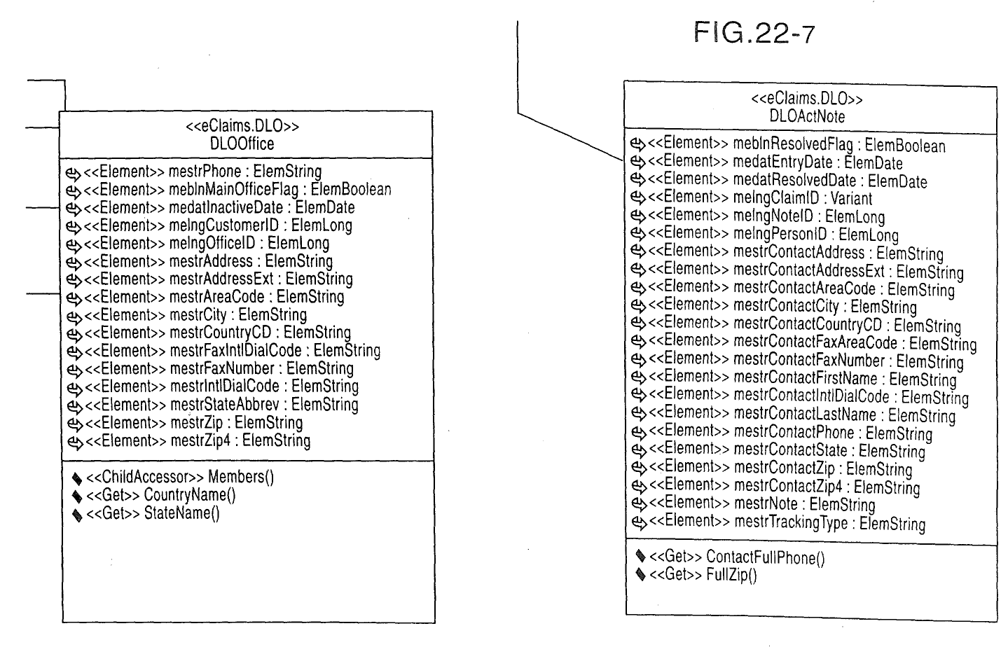

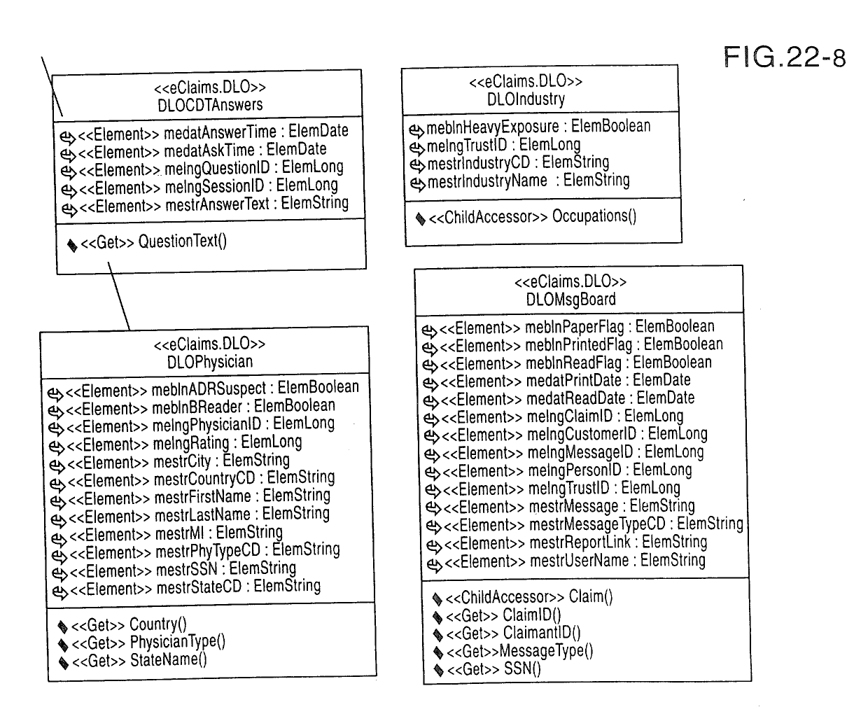

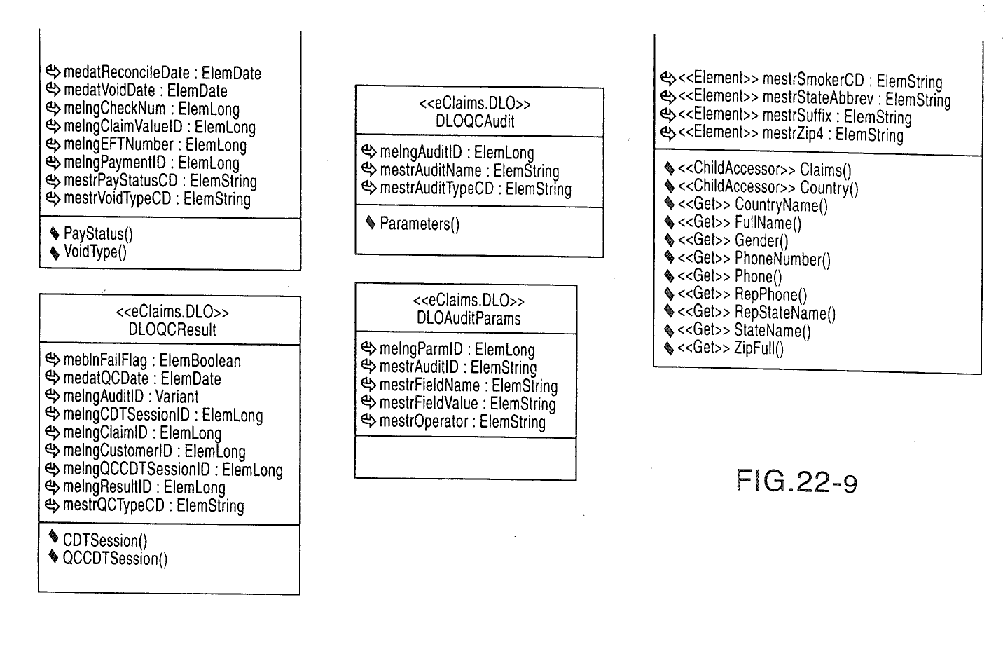

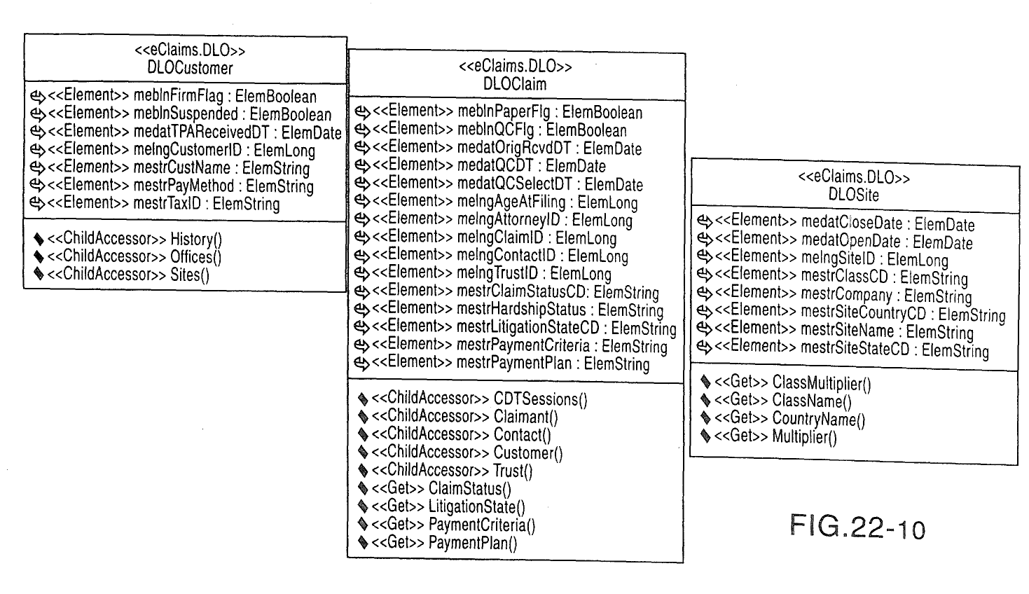

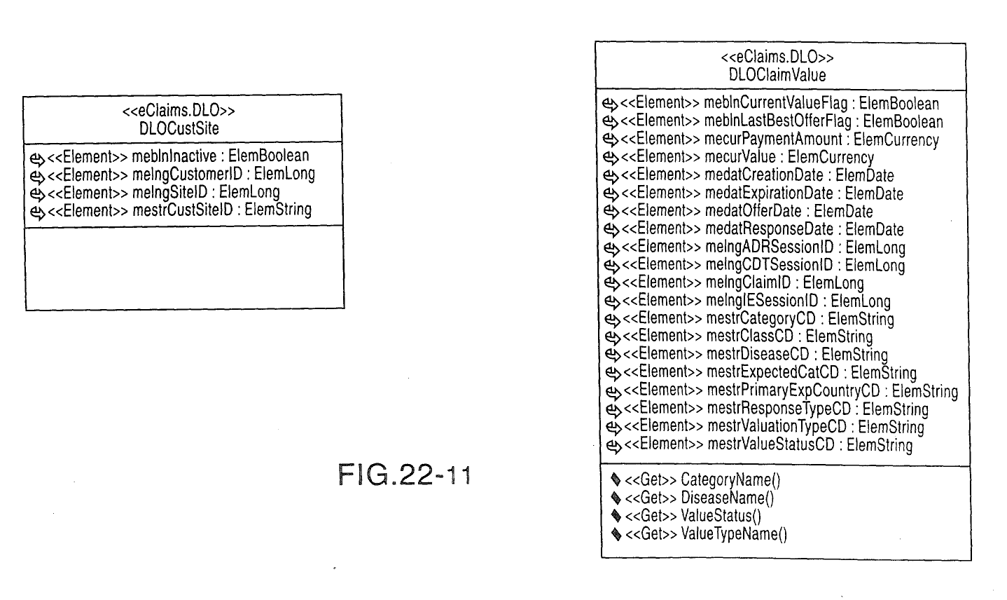

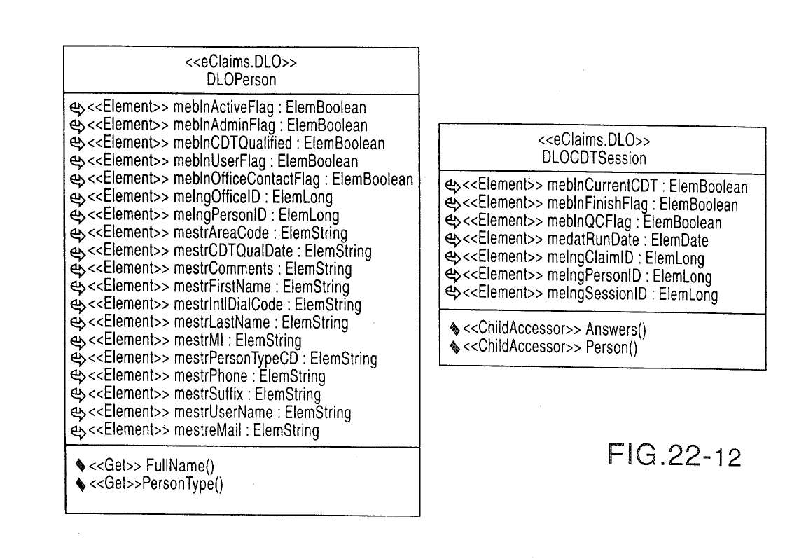

FIGS. 21, 21-1, and 21-2 illustrate examples of the element level objects and their associated properties. FIGS. 22, and 22-1 to 22-6 illustrate examples of the data level objects and their associated properties. Data level objects encapsulate access to a database table or similar data source. All Data Level Objects (DLOs) implement the custom interfaces (DLO and IpersistStream). In addition, they implement the COM interface ObjectControl. All DLOs illustrated in FIGS. 22-1 to 22-6 inherit the methods in DLOBase.

These properties and methods are available through the default interface for the object. In the implementation of the objects, the code for all of these methods may exist in the objects. This code is standardized and may be produced through a code template. An exampled of a code template is Rational Rose. All objects properties are represented in the Figures as attributes, though they are available through <<Get>> and <<Let>> methods.

The type returned by each item is Variant, subclassed as the object type indicated by the attribute. All attributes have the same default property. Those items with a stereotype of <<ChildAccessor>> return a related object of the given type, Eg: <<ChildAccessor>> Claims( ) in DLOClaimant returns a DLOClaim object which contains all of the claims for that claimant. Additionally, the relationships between the element level objects and the data level objects is shown.

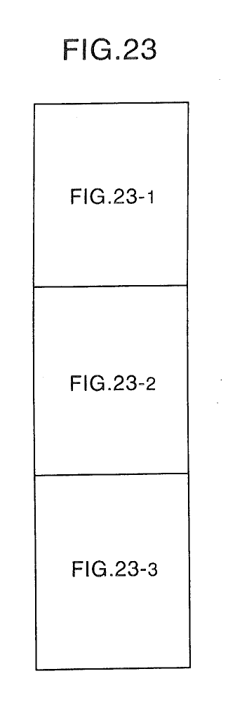

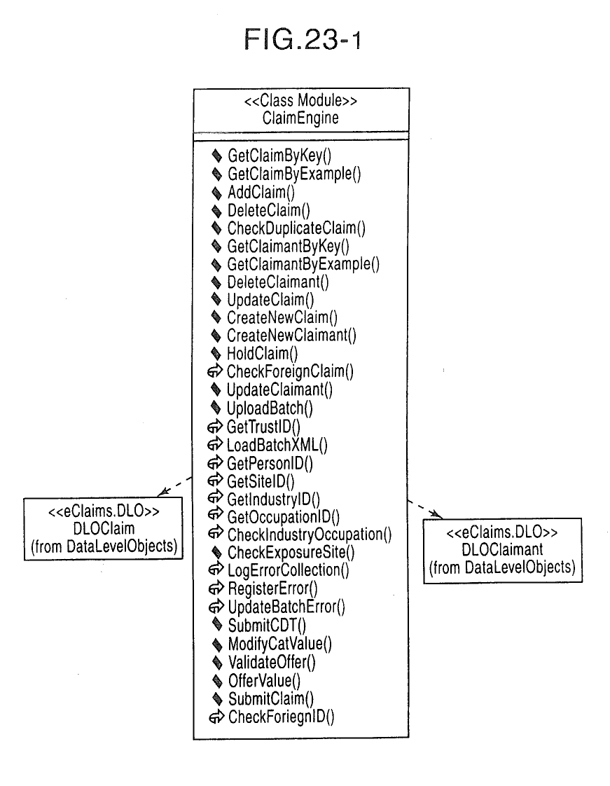

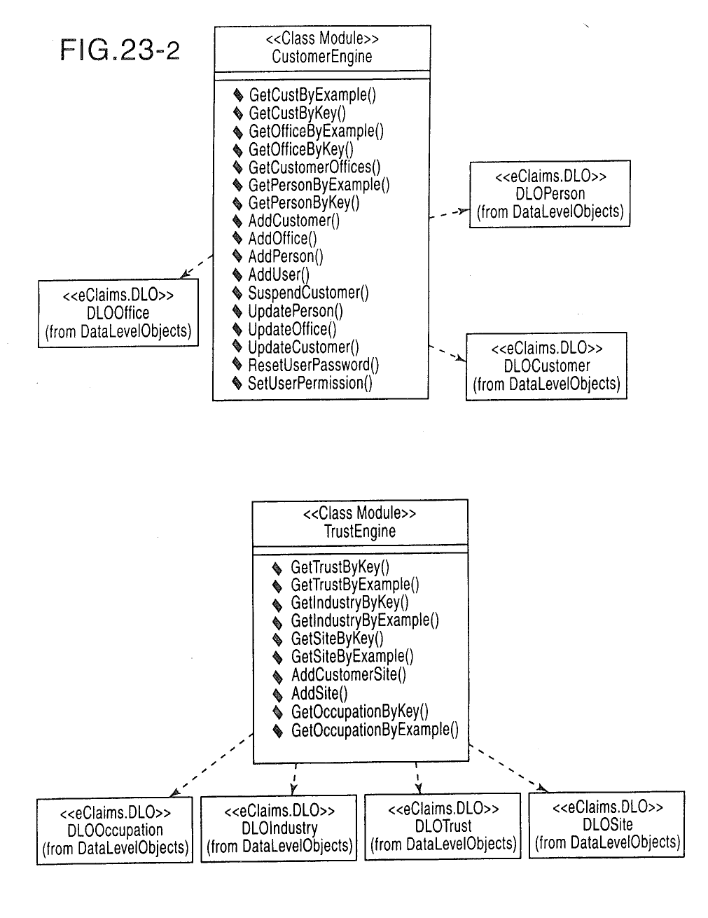

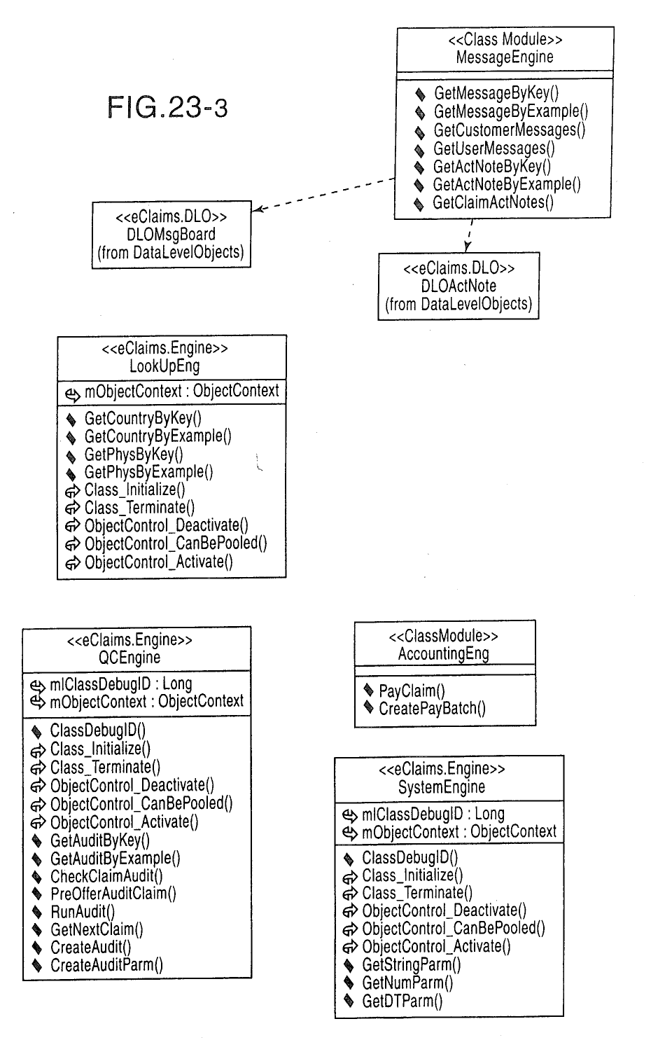

FIGS. 23, 23-1, and 23-2 illustrate examples of the business level objects and their associated properties. The relationship between each business level object and the related data level objects is also illustrated. These Figures are also provided to disclose the current embodiment.

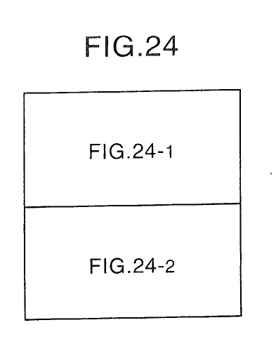

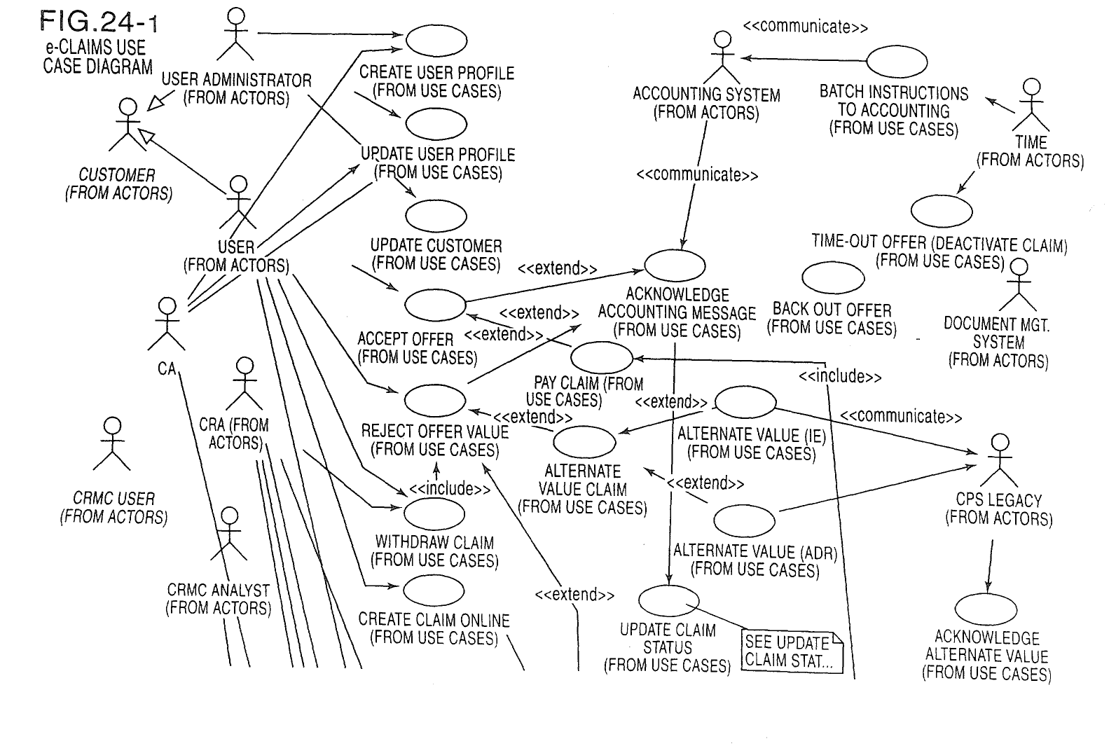

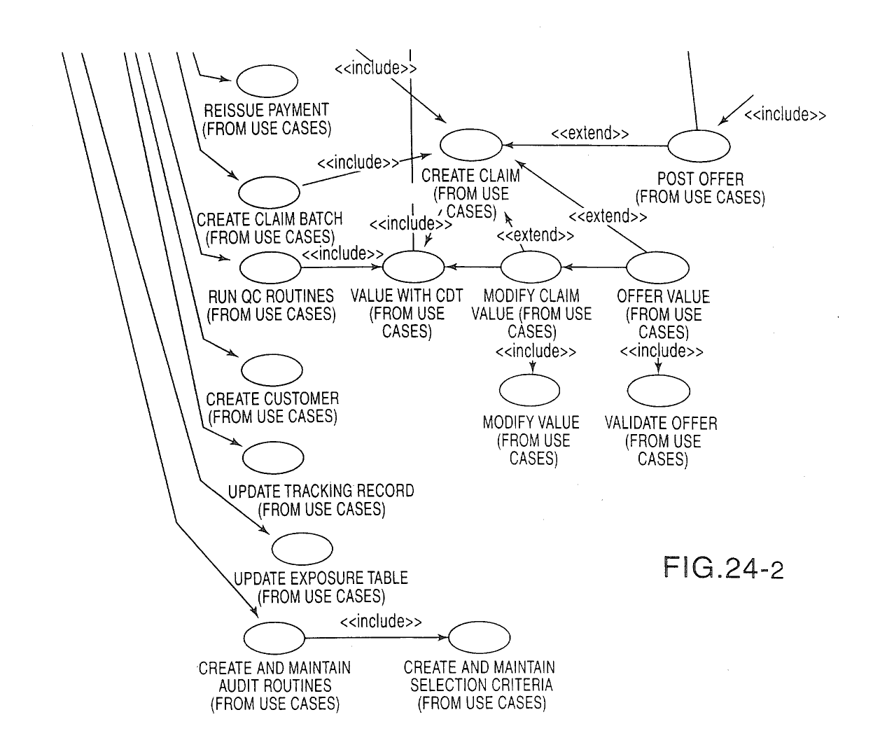

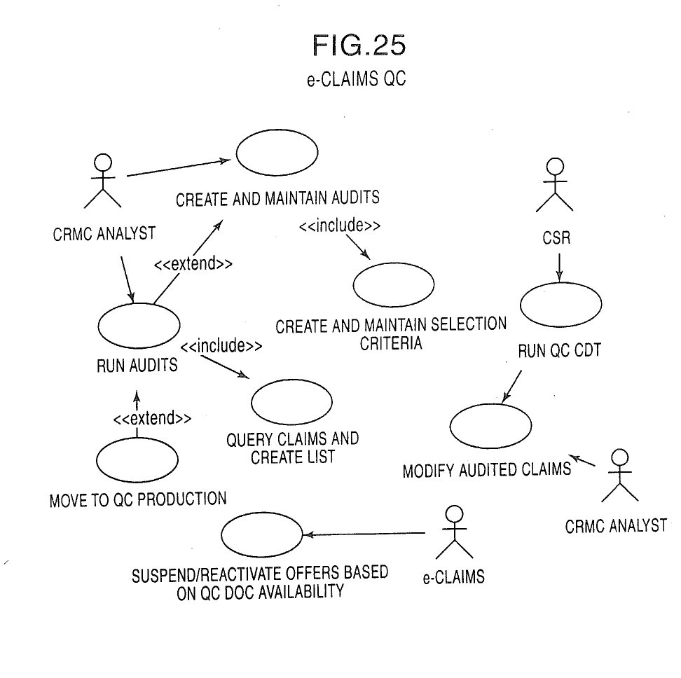

FIGS. 24 and 25 are use case diagrams for the current embodiment. These figures are included in order to provide a complete disclosure of the user interactions enabled by the current embodiment.

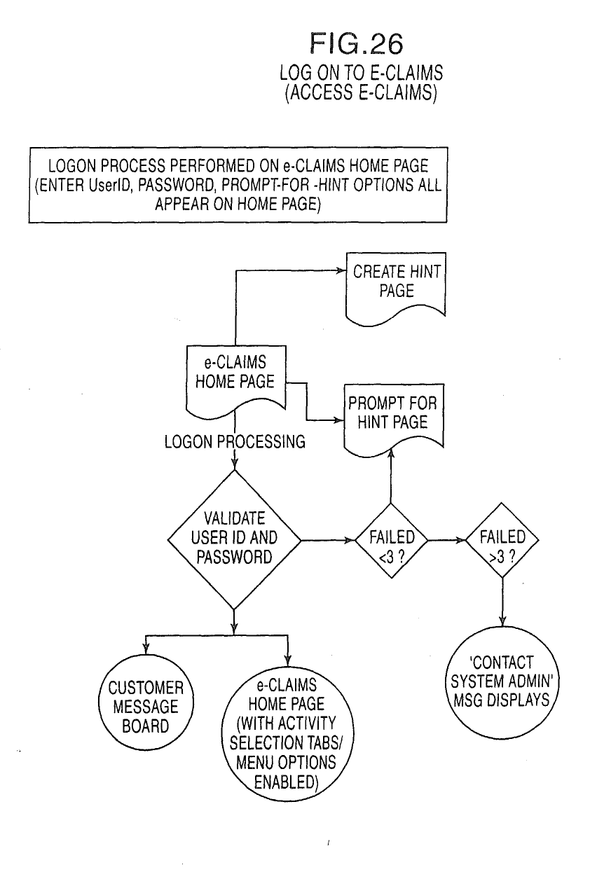

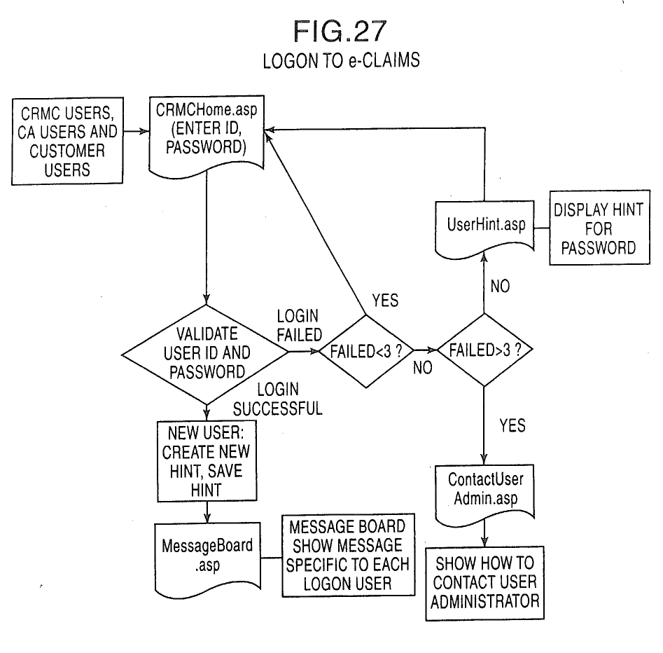

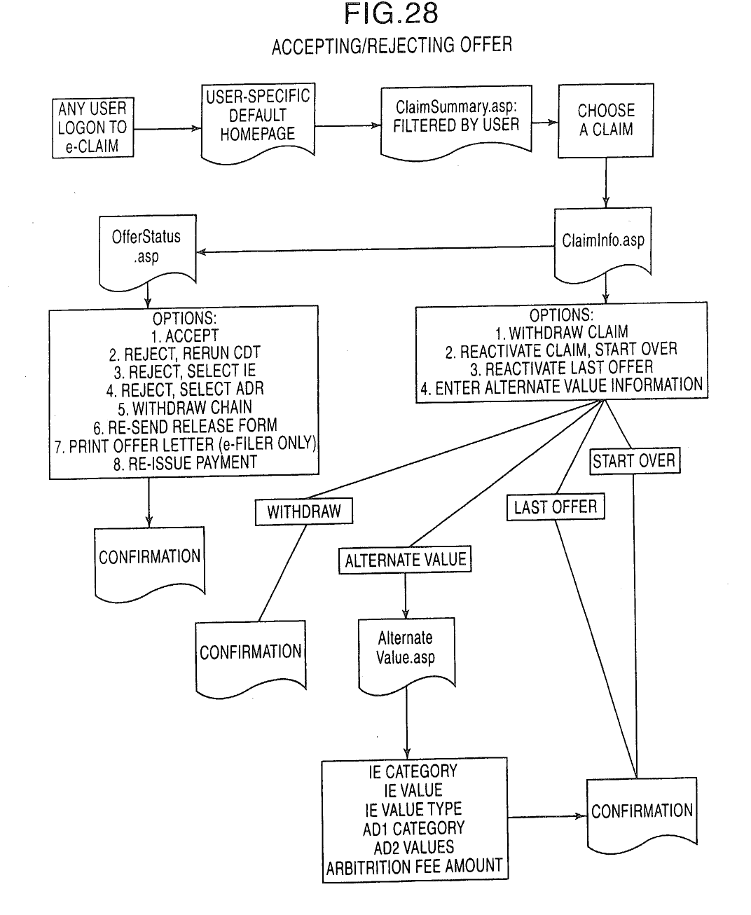

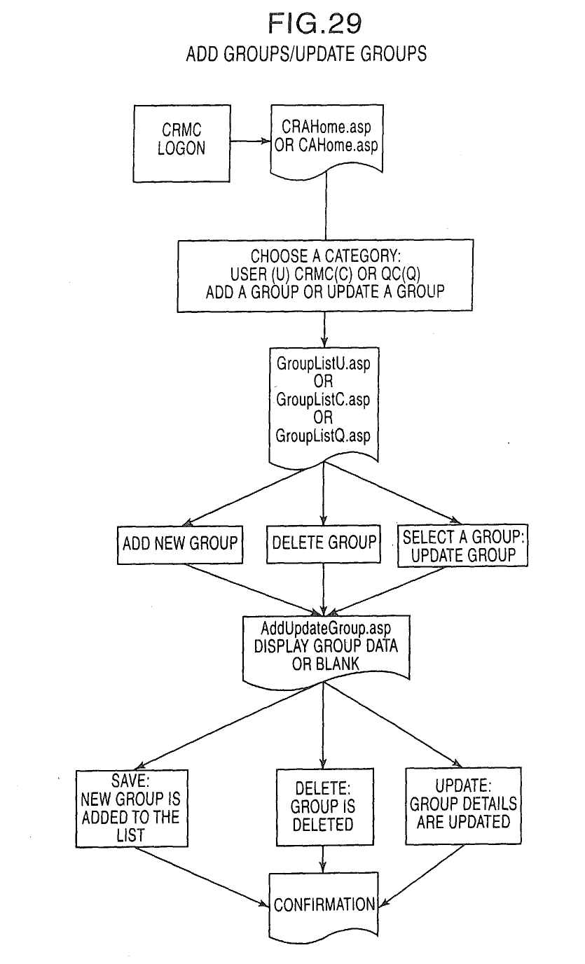

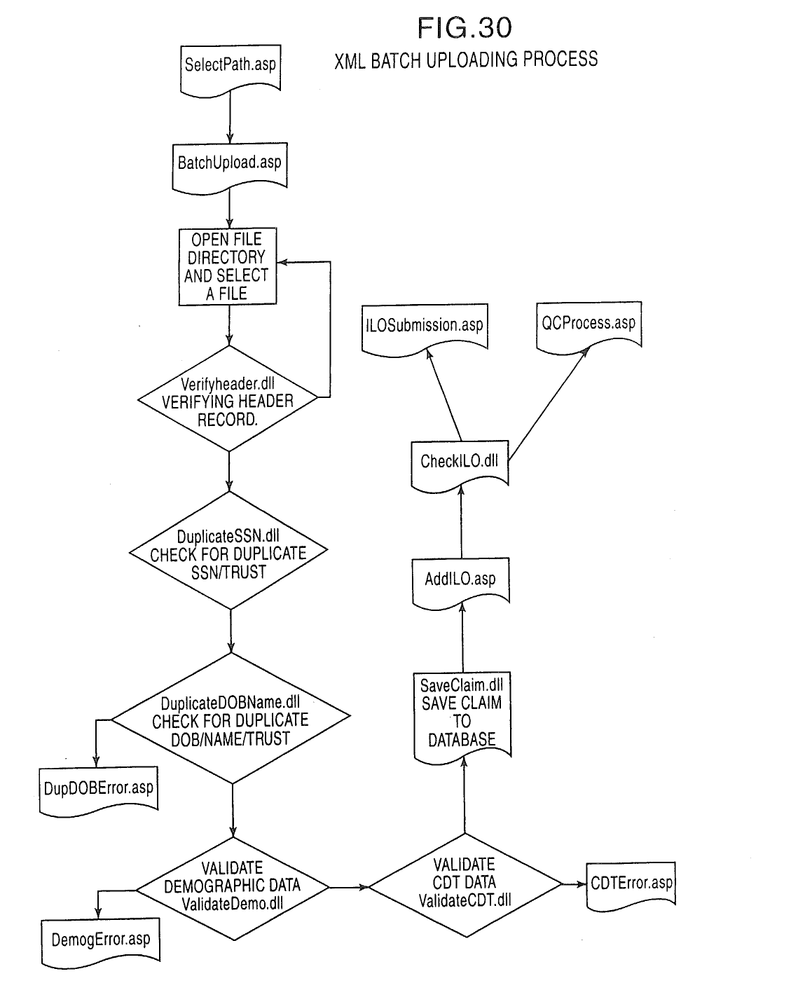

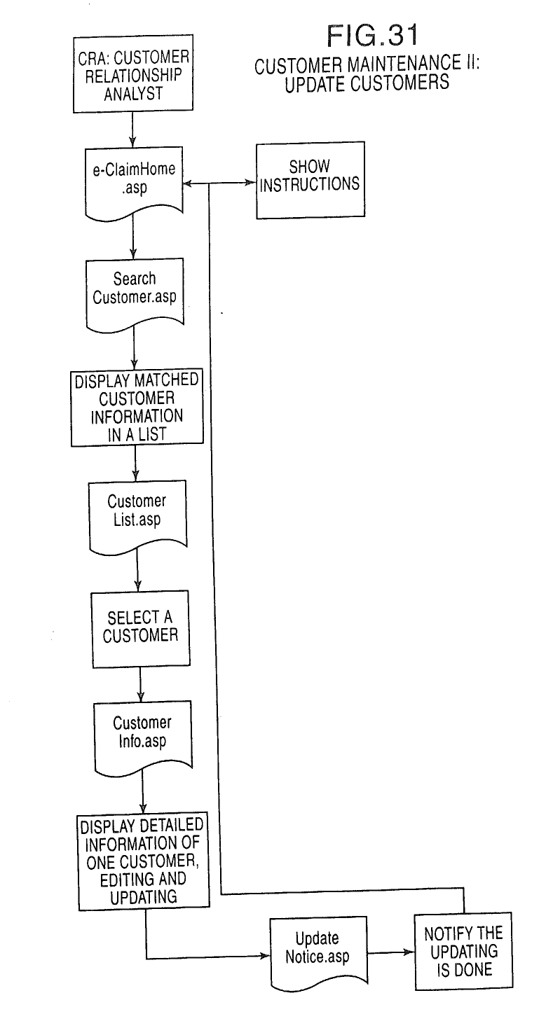

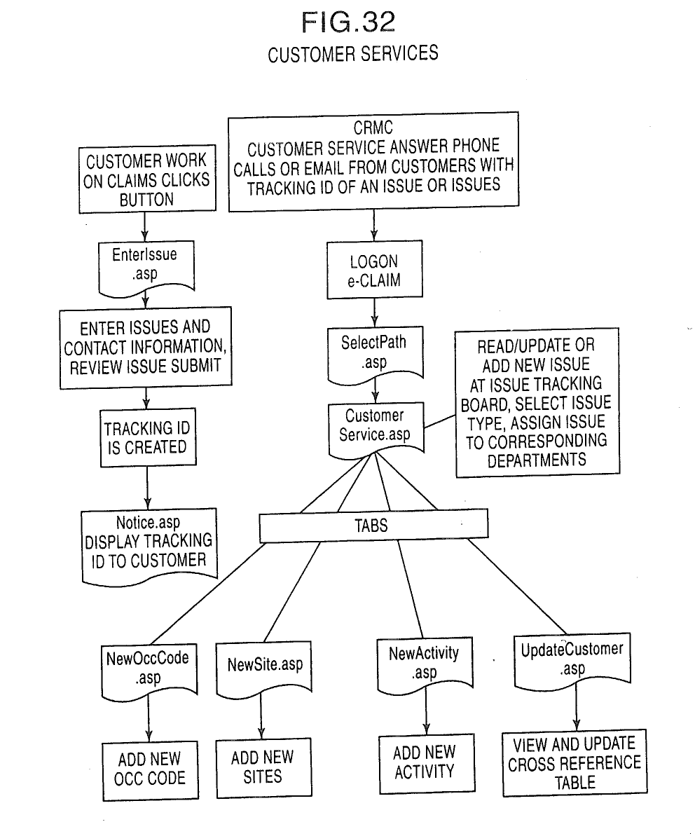

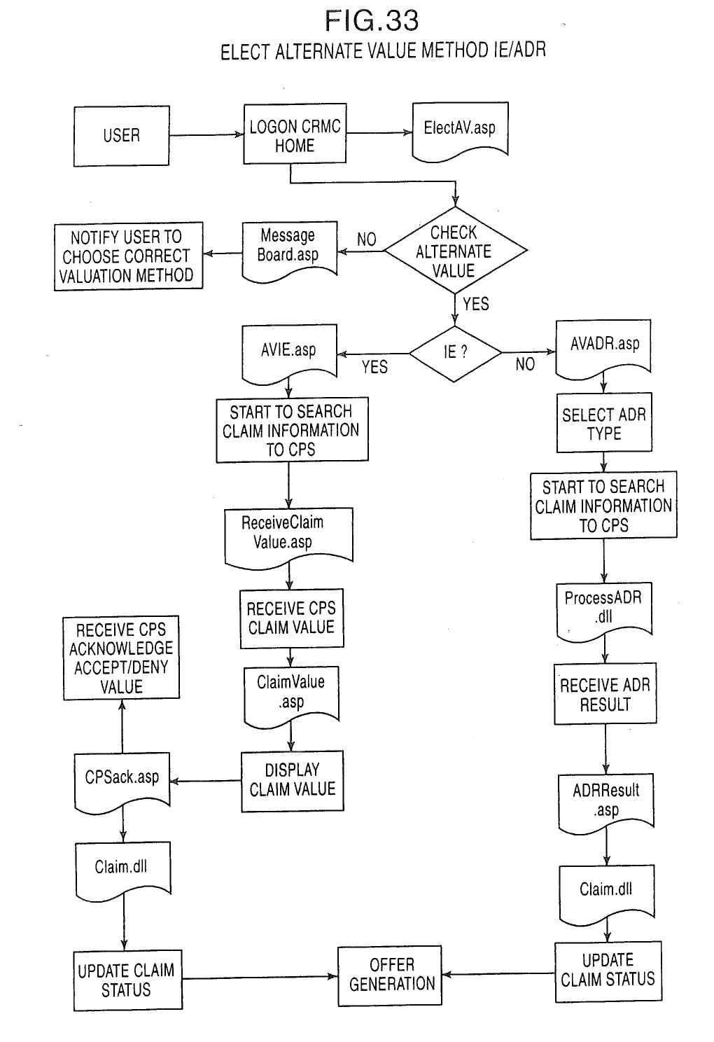

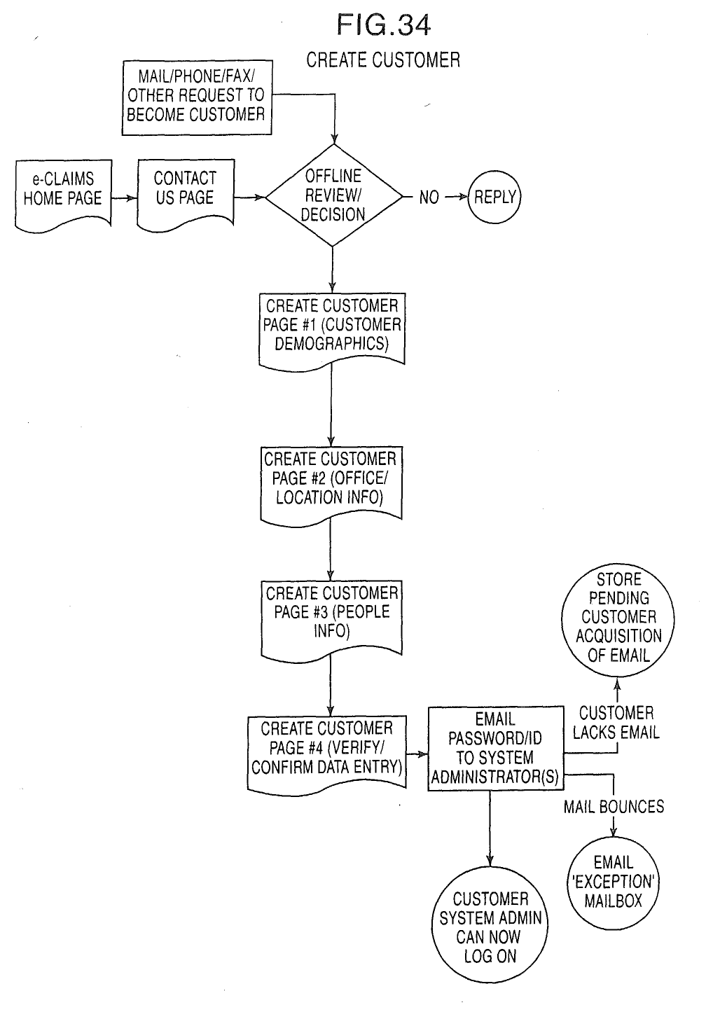

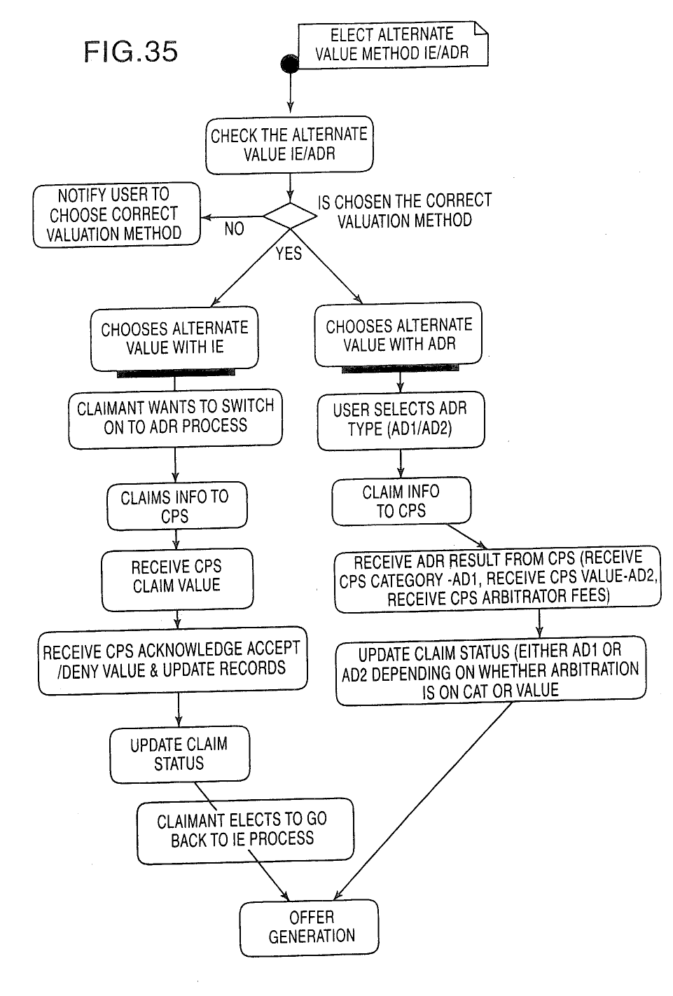

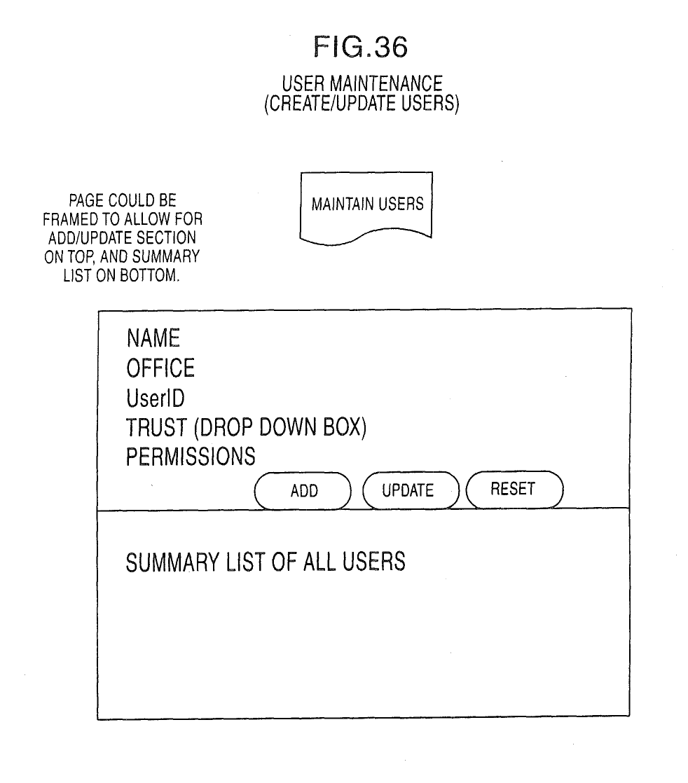

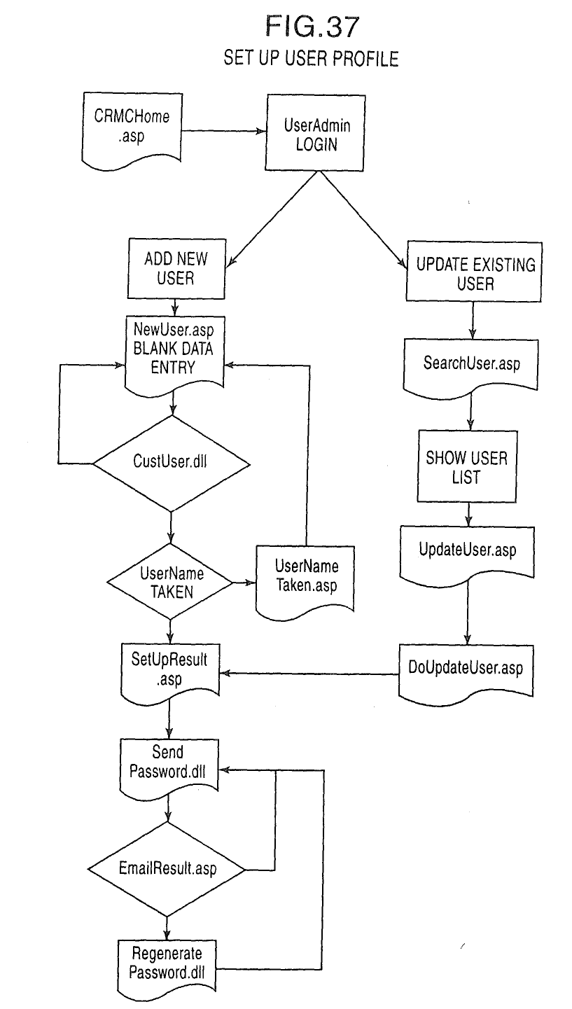

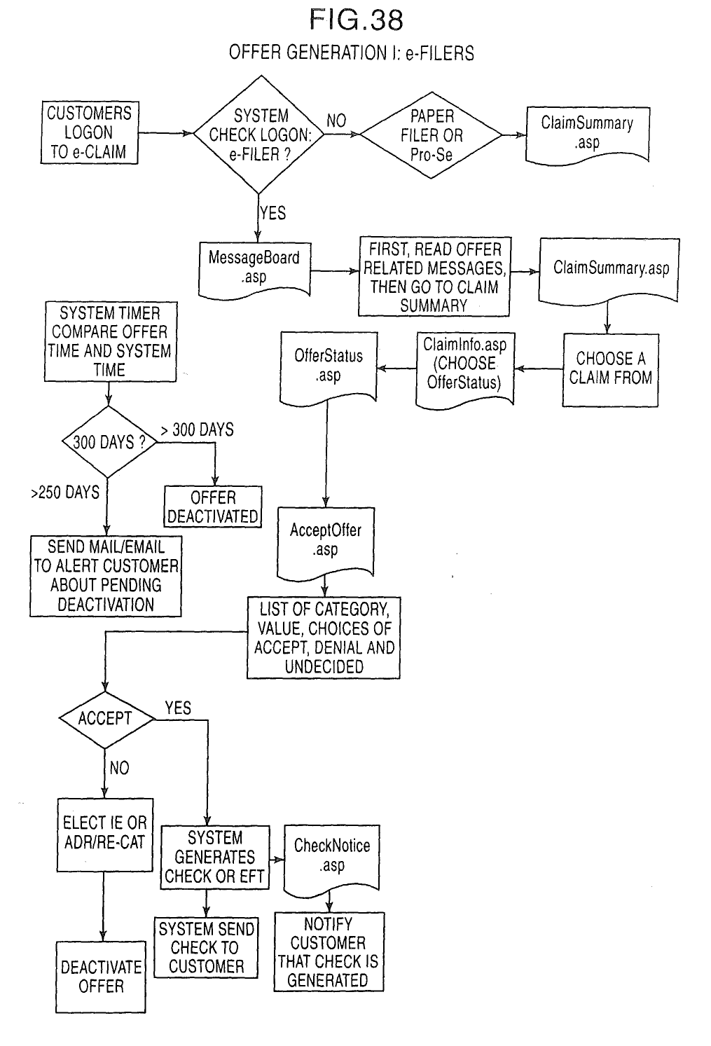

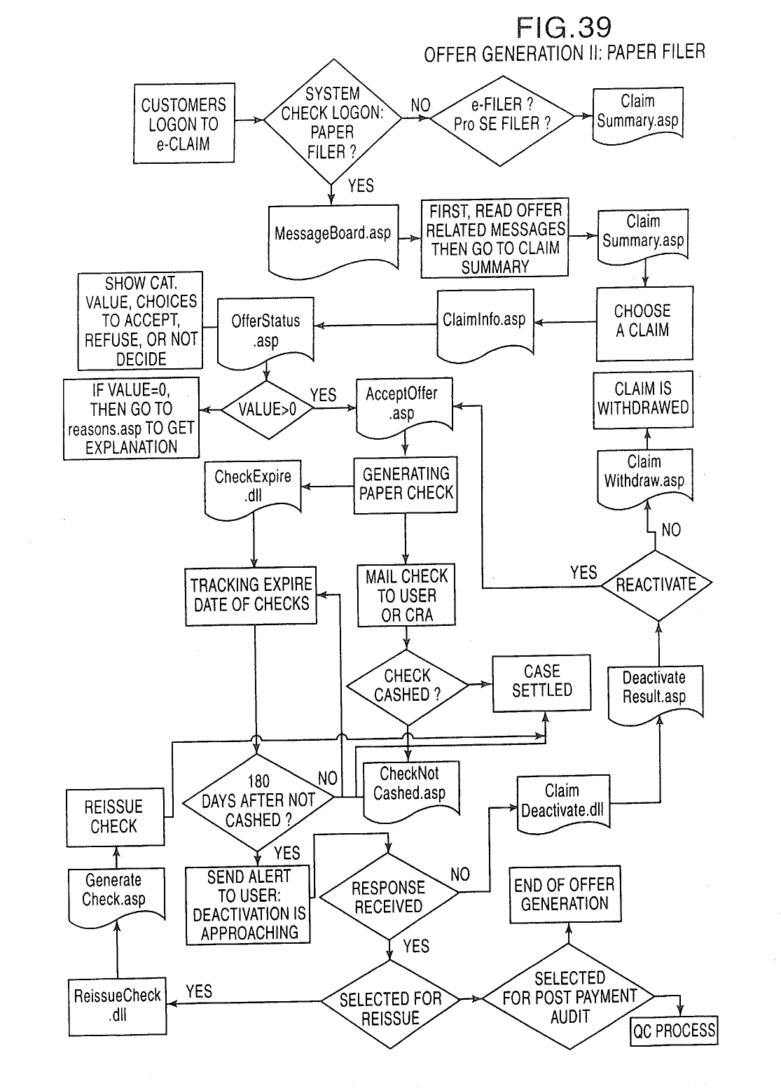

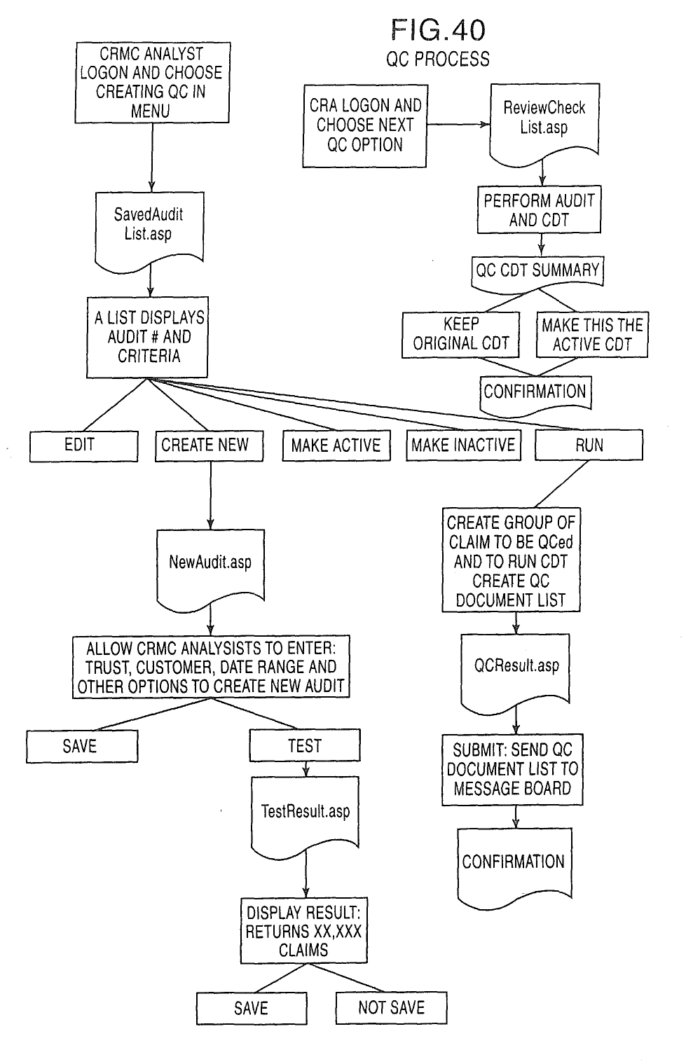

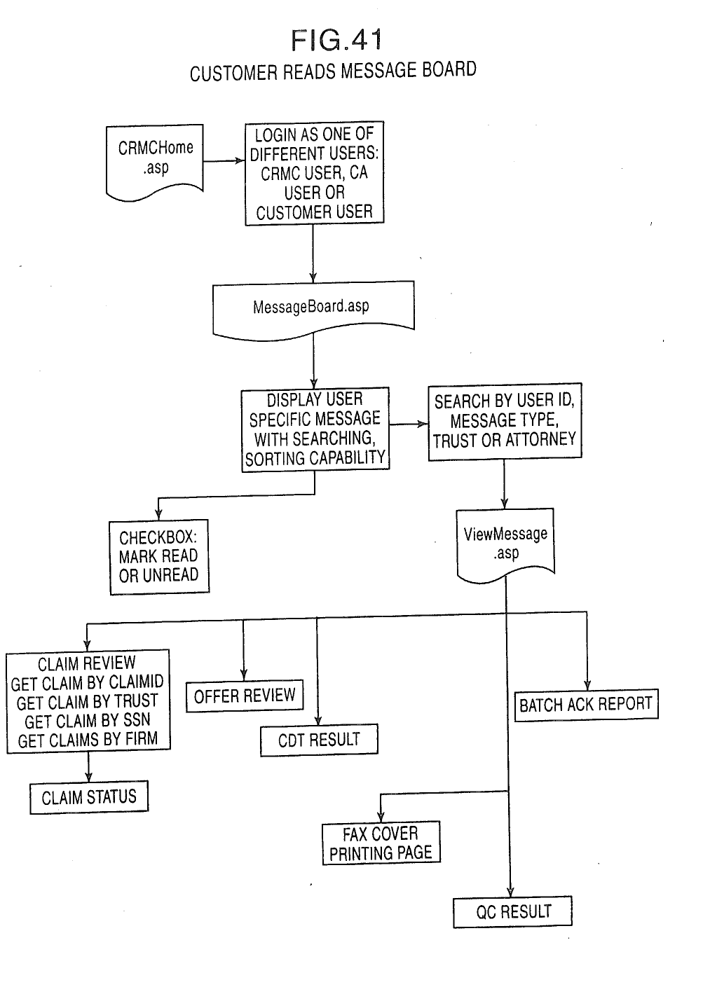

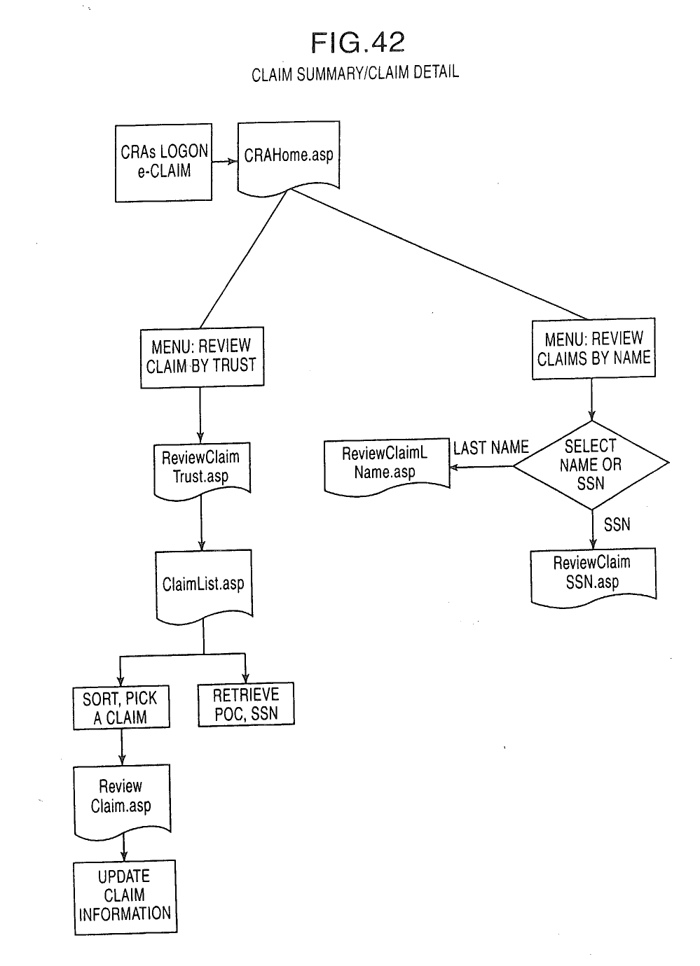

FIGS. 26-42 provide functional flow charts for the exemplary website employing the web-based claim process 10. These flow charts illustrate the functional flow employed in the current embodiment of the website and are provided for a complete disclosure.

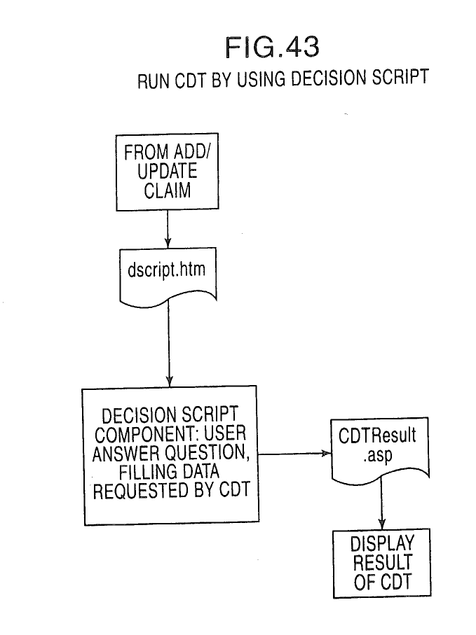

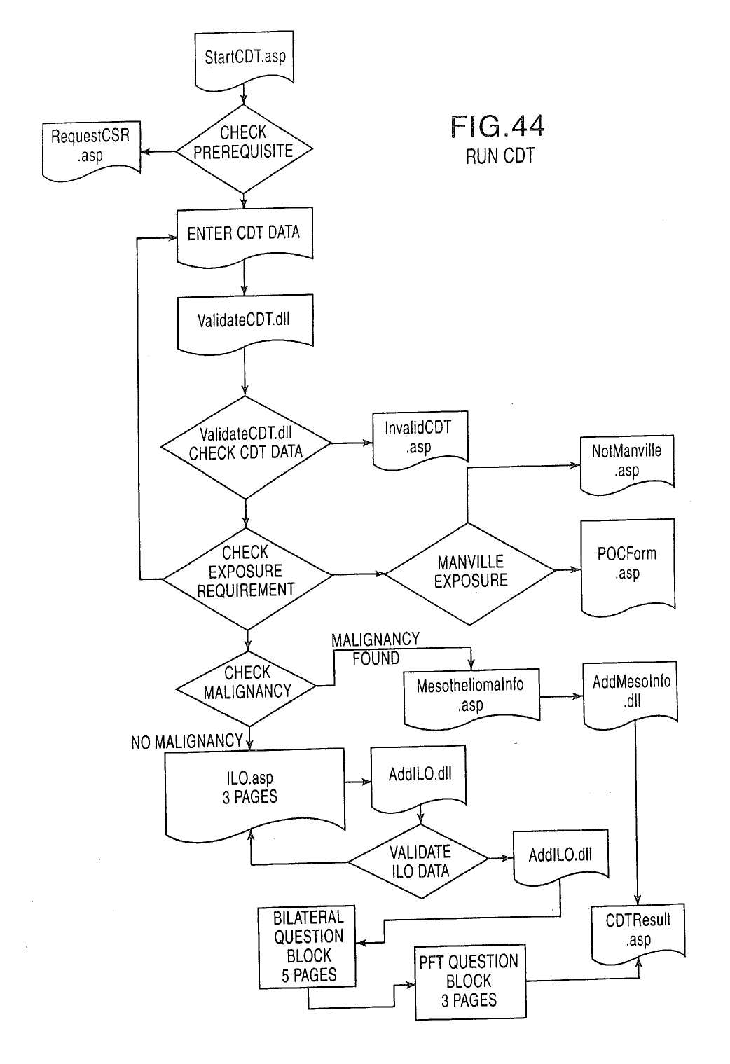

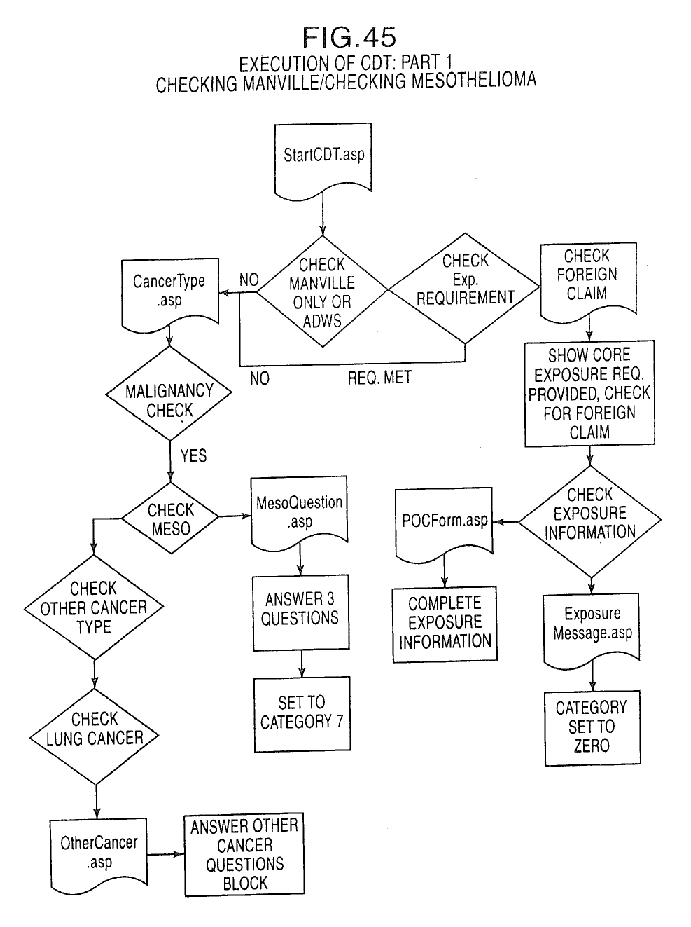

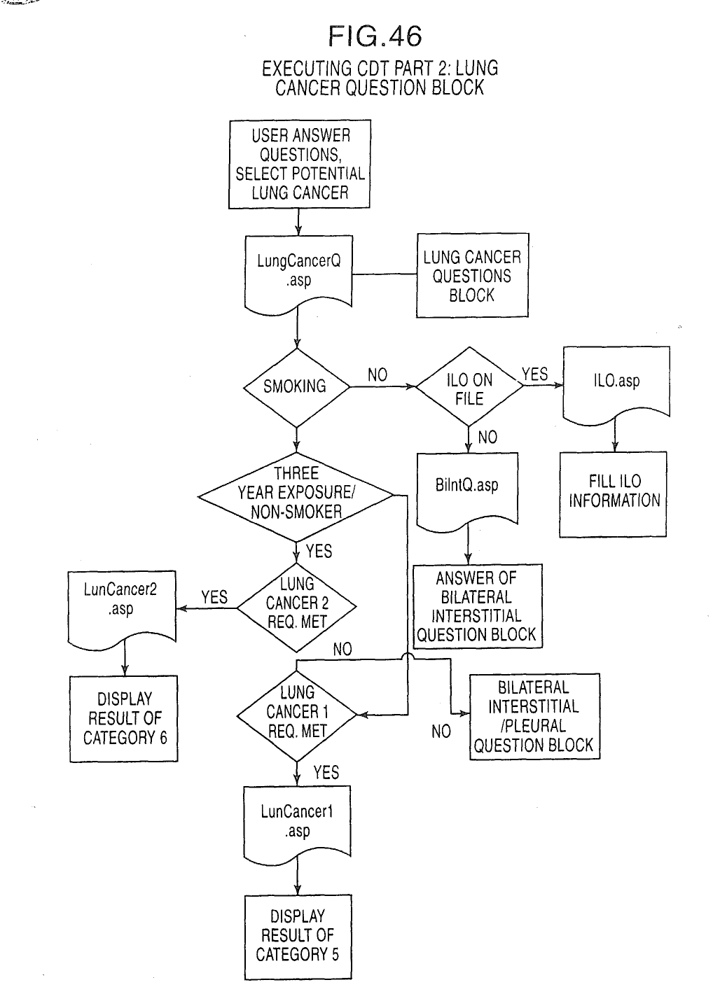

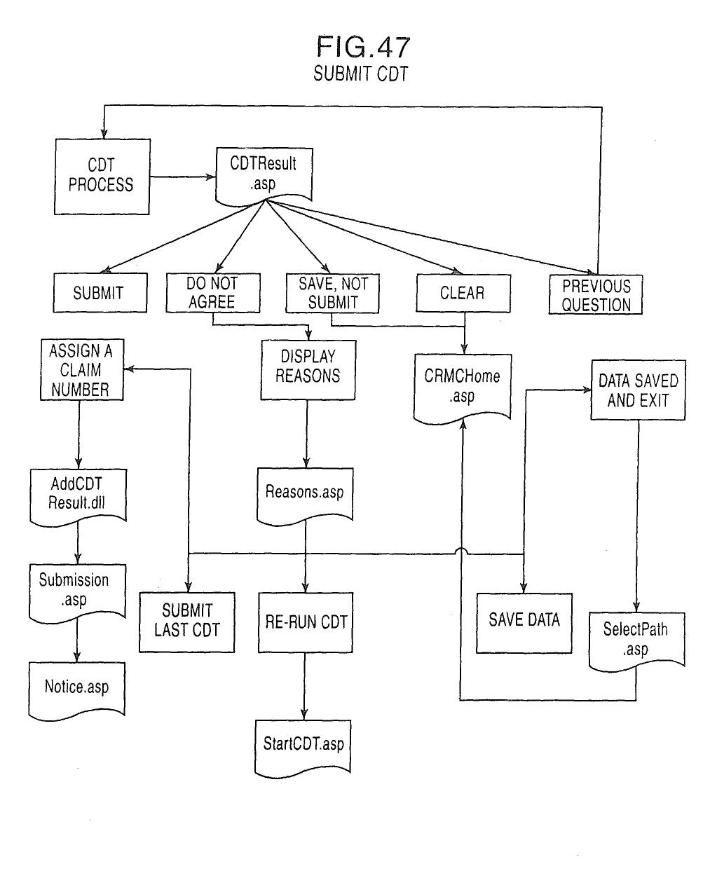

FIGS. 43-47 provide functional flow charts for the website using a web-based CDT process 100. One example of the CDT process 100 is described above, and shown in FIGS. 6 and 7. These flow charts illustrate the functional flow employed in the current embodiment of the website, and are provided for a complete disclosure.

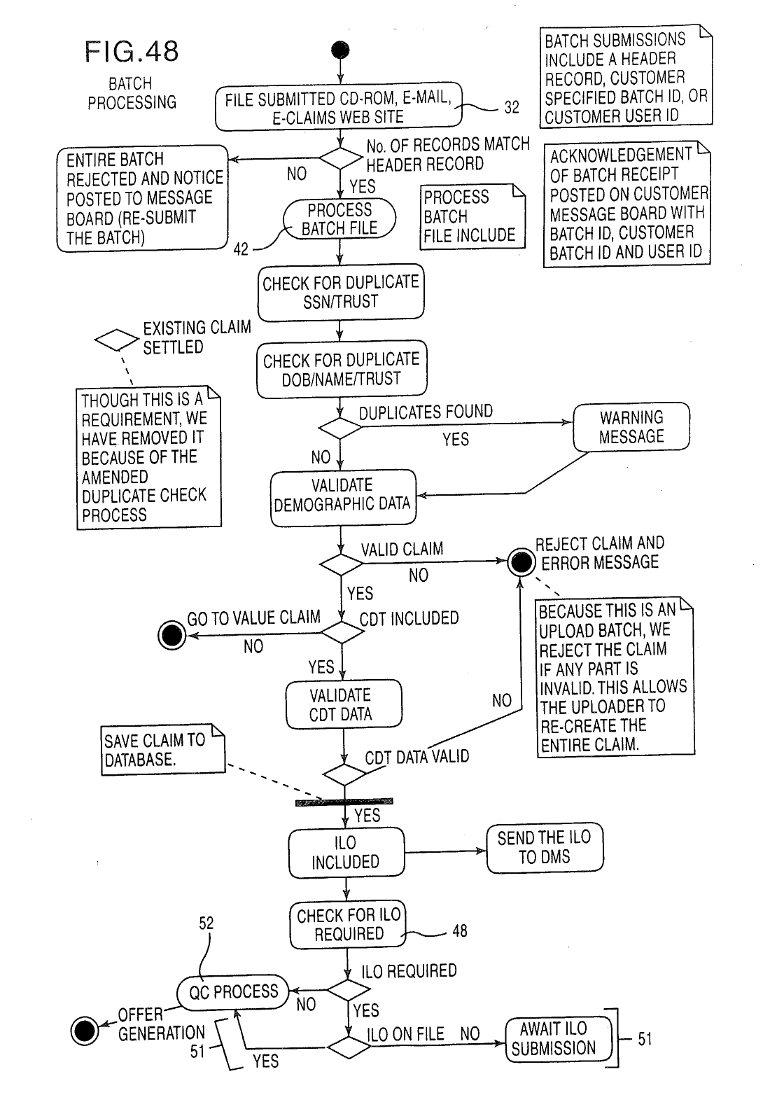

FIGS. 48 and 48-1 to 48-3 illustrate an alternative functional flow chart for the batch claims process shown in FIGS. 3-5. These figures are also provided for a complete disclosure. It is believed that a personal ordinary skill in the art would understand these flow charts, given the disclosure provided above.

All publications and patent applications mentioned in this specification are incorporated by reference to the same extent as if each individual publication or patent application was specifically and individually indicated to be incorporated by reference.

In summary, numerous benefits have been described that result from employing the invention's concepts. The description of the present embodiment has been prepared for the purposes of illustration and description. It is not intended to be exhaustive or to limit the invention to the precise form disclosed. Obvious modifications and variations are possible in light of the above teaching. The embodiment was chosen and described in order to illustrate the principals of the invention, and their practical application to enable one of ordinary skill to utilize the concepts of the invention. The invention now being described, it will be apparent to one of ordinary skill in the art that many changes and modifications can be made, without departing from the spirit or scope of the claims. It is intended that the scope of invention be defined by the following claims.

We claim:

1. A computer implemented method for processing a compensation request, the method comprising:
(a) receiving the compensation request;
(b) processing the compensation request on a computer using a categorization decision tree to determine the value of the compensation request; and
(c) transmitting an offer to settle the compensation request, the value of the offer based on the result of the compensation request processing using the categorization decision tree.

2. The method of claim 1, wherein the compensation request relates to an injury or disease related to asbestos or other toxic material exposure.

3. The method of claim 2 wherein the categorization decision tree implements a court ordered compensation request valuation process.

4. The method of claim 1 further comprising:
verifying that all documentation for the compensation request has been received; and
performing an audit of the received compensation request.

5. The method of claim 1, wherein the categorization decision tree provides a systematic method for valuing a compensation request.

6. The method of claim 5, wherein the systematic method values the compensation request at the highest value for which the requirements are met.

7. The method of claim 1, wherein the categorization decision tree comprises:
(1) providing questions related to the highest award category;
(2) receiving a response to the questions related to the highest award category;
(3) determining if the requirements for the highest award category are met; and
(4) when the requirements for the highest award category are met, exiting the categorization decision tree and returning the value of the award to step (c).

8. The method of claim 7, wherein the categorization decision tree further comprises:
(5) when the requirements for a higher award category are not met, providing questions related to a next lower award category;
(6) receiving a response to the questions related to the next lower award category; and
(7) determining if the requirements for the next lower award category are met; and
(8) when the requirements for the next lower award category are met, exiting the categorization decision tree and returning the value of the award to step (c).

9. The method of claim 7, wherein the categorization decision tree further comprises:
(5) when the requirements for a higher award category are not met, providing questions related to a next lower award category;
(6) receiving a response to the questions related to the next lower award category;
(7) determining if the requirements for the next lower award category are met;
(8) when the claimant meets the requirements for the next lower award category, exiting the categorization decision tree and returning the value of the award to step (c);
(9) repeating steps (5)-(8) until all award categories have been evaluated; and
(10) exiting the categorization decision tree and returning a denial of the compensation request to step (c).

10. A computer implemented method for processing a compensation request, the method comprising:
(a) receiving the compensation request;
(b) processing the compensation request on a computer using a categorization decision tree to determine the value of the compensation request, the categorization decision tree comprising:
(1) providing questions related to the highest award category;
(2) receiving a response to the questions related to the highest award category;
(3) determining if the requirements for the highest award category are met; and
(4) when the requirements for the highest award category are met, exiting the categorization decision tree and returning the value of the award to step (c)
(5) when the requirements for a higher award category are not met, providing questions related to a next lower award category;
(6) receiving a response to the questions related to the next lower award category;
(7) determining if the requirements for the next lower award category are met;
(8) when the requirements for the next lower award category are met, exiting the categorization decision tree and returning the value of the award to step (c);
(9) repeating steps (5)-(8) until all award categories have been evaluated; and
(10) exiting the categorization decision tree and returning a denial of the compensation request to step (c); and
(c) transmitting an offer to settle the compensation request, the value of the offer based on the result of the compensation request processing using the categorization decision tree.

11. A computer implemented method for processing a compensation request, the method comprising:
(a) receiving a compensation request;
(b) processing the compensation request, on a computer programmed to operate as an expert system, to determine the value of the compensation request; and
(c) transmitting an offer to settle the compensation request, the value of the offer based on the result of the compensation request processing using the expert system.

12. The method of claim 11, wherein processing the compensation request on the computer programmed to operate as the expert system comprises:
(1) providing questions related to the highest award category;
(2) receiving a response to the questions related to the highest award category;
(3) determining if the requirements for the highest award category are met; and
(4) when the requirements for the highest award category are met, exiting the expert system and returning the value of the award to step (c).

13. The method of claim 12, wherein processing the compensation request on the computer programmed to operate as the expert system further comprises:
(5) when the requirements for a higher award category are not met, providing questions related to a next lower award category;
(6) receiving a response to the questions related to the next award category;
(7) determining if the requirements for the next lower award category are met; and
(8) when the requirements for the next lower award category are met, exiting the expert system and returning the value of the award to step (c).

14. The method of claim 12, wherein processing the compensation request on the computer programmed to operate as the expert system further comprises:
(5) when the requirements for a higher award category are not met, providing questions related to a next lower award category;
(6) receiving a response to the questions related to the next lower award category;
(7) determining if the requirements for the next lower award category are met;
(8) when the requirements for the next lower award category are met, exiting the expert system and returning the value of the award to step (c);
(9) repeating steps (5)-(8) until all award categories have been evaluated; and
(10) exiting the expert system and returning a denial of the compensation request to step (c).

15. A computer implemented method for processing a compensation request, the method comprising:
(a) receiving the compensation request;
(b) processing the compensation request on a computer using an expert system to determine the value of the compensation request, the compensation request processing comprising,
(1) providing questions related to the highest award category,
(2) receiving a response to the questions related to the highest award category,
(3) determining if the requirements for the highest award category are met,
(4) when the requirements for the highest award category are met, exiting the expert system and returning the value of the claimants award to step (c),
(5) when the requirements for a higher award category are not met, providing questions related to a next lower award category,
(6) receiving a response to the questions related to the next lower award category,
(7) determining if the requirements for the next lower award category are met,
(8) when the requirements for the next lower award category are met, exiting the expert system and returning the value of the award to step (c),
(9) repeating steps (5)-(8) until all award categories have been evaluated, and
(10) exiting the expert system and returning a denial of the compensation request to step (c); and
(c) transmitting an offer to settle the compensation request, the value of the offer based on the result of the compensation request processing using the expert system.

16. A computer readable device containing a program for processing compensation requests, the device comprising:
a computer readable medium;
a processing data structure for processing the compensation request using a categorization decision tree to determine the value of the compensation request, the processing data structure stored on the medium.

17. The computer readable device of claim 16 further comprising:
a transmitting data structure for transmitting an offer to settle the compensation request, the value of the offer based on the result of the compensation request processing using the categorization decision tree, the transmitting data structure stored on the medium.

18. The computer readable device of claim 17, wherein the categorization decision tree comprises:
(1) question means for providing questions related to the highest award category;
(2) response receiving means for receiving a response to the questions related to the highest award category;
(3) requirements determining means for determining if the requirements for the highest award category are met; and
(4) exiting means for exiting the categorization decision tree and returning the value of the award to the transmitting data structure when the requirements determining means determines that the requirements for the highest award category are met.

19. The computer readable device of claim 18, wherein the categorization decision tree further comprises:
(5) next question providing means for providing questions related to a next lower award category when the requirements for a higher award category are not met;
(6) next response receiving means for receiving a response to the questions related to the next lower award category;
(7) next determining means for determining if the requirements for the next lower award category are met; and
(8) exiting means for exiting the categorization decision tree and returning the value of the award to the transmitting data structure when the next determining means determines that the requirements for the next lower award category are met.

20. The computer readable device of claim 18, wherein the categorization decision tree further comprises:
(5) next question providing means for providing questions related to a next lower award category when the requirements for a higher award category are not met;
(6) next response receiving means for receiving a response to the questions related to the next lower award category;
(7) next determining means for determining if the requirements for the next lower award category are met;
(8) next exiting means for exiting the categorization decision tree and returning the value of the award to the transmitting data structure when the next determining means determines that the requirements for the next lower award category are met;
(9) repeating means for repeating the processing of (5)-(8) until all award categories have been evaluated; and
(10) denial exiting means for exiting the categorization decision tree and returning a denial of the compensation request to the transmitting data structure.

21. A computer readable device containing a program for processing a compensation request, the device comprising:
a computer readable medium;
a processing data structure for processing the compensation request using a categorization decision tree to determine the value of the compensation request, the processing data structure stored on the medium; and
a transmitting data structure for transmitting an offer to settle the compensation request, the value of the offer based on the result of the compensation request processing using the categorization decision tree, the transmitting data structure stored on the medium, wherein
the categorization decision tree comprises,
(1) question means for providing questions related to the highest award category,
(2) response receiving means for receiving a response to the questions related to the highest award category,
(3) requirements determining means for determining if the requirements for the highest award category are met,
(4) exiting means for exiting the categorization decision tree and returning the value of the award to the transmitting data structure when the requirements determining means determines that the requirements for the highest award category are met,
(5) next question providing means for providing questions related to a next lower award category when the requirements for a higher award category are not met,
(6) next response receiving means for receiving a response to the questions related to the next lower award category,
(7) next determining means for determining if the requirements for the next lower award category are met,
(8) next exiting means for exiting the categorization decision tree and returning the value of the award to the transmitting data structure when the next determining means determines that the requirements for the next lower award category are met,
(9) repeating means for repeating (5)-(8) until all award categories have been evaluated, and
(10) denial exiting means for exiting the categorization decision tree and returning a denial of the compensation request to the transmitting data structure.

22. A computer system for processing a compensation request, the system comprising:
a computer comprising: a processor; an input device for inputting data into the computer; an output device for outputting data from the computer; and at least one storage medium for storing instructions for the processor;
a processing data structure for processing the compensation request using a categorization decision tree to determine the value of the compensation request, the processing data structure stored on the medium.

23. The computer system of claim 22, further comprising:
a transmitting data structure for transmitting an offer to settle the compensation request, the value of the offer based on the result of the compensation request processing using the categorization decision tree, the transmitting data structure stored on the medium.

24. The computer readable device of claim 23, wherein the categorization decision tree comprises:
(1) question means for providing questions related to the highest award category;
(2) response receiving means for receiving a response to the questions related to the highest award category;
(3) requirements determining means for determining if the requirements for the highest award category are met; and
(4) exiting means for exiting the categorization decision tree and returning the value of the award to the transmitting data structure when the requirements determining means determines that the requirements for the highest award category are met.

25. The computer readable device of claim 24, wherein the categorization decision tree further comprises:
(5) next question providing means for providing questions related to a next lower award category when the requirements for a higher award category are not met;
(6) next response receiving means for receiving a response to the questions related to the next lower award category;
(7) next determining means for determining if the requirements for the next lower award category are met; and
(8) exiting means for exiting the categorization decision tree and returning the value of the award to the transmitting data structure when the next determining means determines that the requirements for the next lower award category are met.

26. The computer readable device of claim 24, wherein the categorization decision tree further comprises:
(5) next question providing means for providing questions related to a next lower award category when the requirements for a higher award category are not met;
(6) next response receiving means for receiving a response to the questions related to the next lower award category;
(7) next determining means for determining if the requirements for the next lower award category are met;
(8) exiting means for exiting the categorization decision tree and returning the value of the award to the transmitting data structure when the next determining means determines that the requirements for the next lower award category are met;
(9) repeating means for repeating (5)-(8) until all award categories have been evaluated; and
(10) denial exiting means for exiting the categorization decision tree and returning a denial of the compensation request to the transmitting data structure.

27. A computer system for processing a compensation request, the system comprising:
a computer comprising: a processor; an input device for inputting data into the computer; an output device for outputting data from the computer; and at least one storage medium for storing instructions for the processor;
a processing data structure for processing the compensation request using a categorization decision tree to determine the value of the compensation request, the processing data structure stored on the medium; and
a transmitting data structure for transmitting an offer to settle the compensation request, the value of the offer based on the result of the compensation request processing using the categorization decision tree, the transmitting data structure stored on the medium, wherein
the categorization decision tree comprises,
(1) question means for providing questions related to the highest award category,
(2) response receiving means for receiving a response to the questions related to the highest award category,
(3) requirements determining means for determining if the requirements for the highest award category are met,
(4) exiting means for exiting the categorization decision tree and returning the value of the award to the transmitting data structure when the requirements determining means determines that the requirements for the highest award category are met,
(5) next question providing means for providing questions related to a next lower award category when the requirements for a higher award category are not met,
(6) next response receiving means for receiving a response to the questions related to the next lower award category,
(7) next determining means for determining if the requirements for the next lower award category are met,
(8) exiting means for exiting the categorization decision tree and returning the value of the award to the transmitting data structure when the next determining means determines that the requirements for the next lower award category are met,
(9) repeating means for repeating (5)-(8) until all award categories have been evaluated, and
(10) denial exiting means for exiting the categorization decision tree and returning a denial of the compensation request to the transmitting data structure.
